(19) United States
(12) Patent Application Publication
(10) Pub. No.: US 2025/0159516 A1
(43) Pub. Date: May 15, 2025

(54) REPORTING ENHANCEMENTS FOR USER EQUIPMENTS

(71) Applicant: QUALCOMM Incorporated, San Diego, CA (US)

(72) Inventors: Shankar KRISHNAN, San Diego, CA (US); Rajeev KUMAR, San Diego, CA (US); Umesh PHUYAL, San Diego, CA (US); Bharat SHRESTHA, San Diego, CA (US)

(21) Appl. No.: 18/510,455

(22) Filed: Nov. 15, 2023

(51) Int. Cl. H04W 24/10; H04W 36/32

(52) U.S. Cl. CPC H04W 24/10; H04W 36/328

(57) ABSTRACT

Some examples of the techniques described herein relate to methods, systems, devices, and apparatuses that support reporting enhancements for user equipments (UEs). An aerial UE may be configured to collect data based on aerial UE-specific events or based on a height-dependent area scope. For example, aerial UE events or a height-specific area scope may be utilized to trigger the collection of data. Data may be collected when a collection rule is satisfied. In some approaches, an aerial UE may collect data for height-specific automatic neighbor relation (ANR) tables. For instance, a network entity may configure a UE to report cell global identities (CGIs) of cells detected at a specific altitude or within an altitude range. Successful handover reports (SHRs) or successful primary secondary cell (PSCell) reports (SPRs) may be generated by an aerial UE using one or more data collection triggers.

### FIELD OF TECHNOLOGY

The following relates to wireless communication, including reporting enhancements for user equipments.

### BACKGROUND

Wireless communication systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

Some examples of the techniques described herein relate to methods, systems, devices, and apparatuses that support reporting enhancements for user equipments (UEs). An aerial UE may be configured to collect data based on aerial UE-specific events or based on a height-dependent area scope. For example, aerial UE events or a height-specific area scope may be utilized to trigger the collection of data to enhance coverage and capacity at a specific altitude. Data (e.g., data for a report, logged minimization of drive time (MDT) data, among other examples) may be collected when a collection rule (e.g., altitude condition) is met, when a signal quality condition is met, or when the UE is located outside of a restricted zone. In some approaches, an aerial UE may collect data for height-specific automatic neighbor relation (ANR) tables. For instance, a network entity may configure a UE to report cell global identities (CGIs) of cells detected at a specific altitude or within an altitude range. Additional data types may be provided in reports, such as a UE type indication in a self-organizing network (SON) report with UE altitude or UE characteristics. For example, successful handover reports (SHRs) or successful primary secondary cell (PSCell) change reports (SPRs) may be generated by an aerial UE using one or more data collection triggers (e.g., when a UE's altitude satisfies an altitude threshold). Some reports (e.g., random access reports, radio link failure (RLF) reports, SHRs, SPRs, among other examples) may be enhanced to include data indicating an altitude of the UE, characteristics of the UE (e.g., antenna type, antenna direction, antenna mounting), or a detected aerial UE density in the UE vicinity at the time of measurement.

A method for wireless communications by a UE is described. The method may include receiving, from a network entity, configuration information for transmission of a report of UE-collected data associated with relational information for one or more network nodes and a collection rule, where the UE is an aerial UE and the collection rule is based on an altitude condition for the UE, and transmitting the report to the network entity in accordance with the configuration information, where the report indicates the UE-collected data associated with the relational information for the one or more network nodes in response to a satisfaction of the collection rule.

An apparatus for wireless communications is described. The apparatus may include memory, a transceiver, and at least one processor of a UE, the at least one processor coupled with the memory and the transceiver. The at least one processor may be configured to cause the UE to receive, from a network entity, configuration information for transmission of a report of UE-collected data associated with relational information for one or more network nodes and a collection rule, where the UE is an aerial UE and the collection rule is based on an altitude condition for the UE, and transmit the report to the network entity in accordance with the configuration information, where the report indicates the UE-collected data associated with the relational information for the one or more network nodes in response to a satisfaction of the collection rule.

Another apparatus for wireless communications is described. The apparatus may include means for receiving, from a network entity, configuration information for transmission of a report of UE-collected data associated with relational information for one or more network nodes and a collection rule, where the UE is an aerial UE and the collection rule is based on an altitude condition for the UE, and means for transmitting the report to the network entity in accordance with the configuration information, where the report indicates the UE-collected data associated with the relational information for the one or more network nodes in response to a satisfaction of the collection rule.

A non-transitory computer-readable medium storing code is described. The code may include instructions executable by one or more processors to receive, from a network entity, configuration information for transmission of a report of UE-collected data associated with relational information for one or more network nodes and a collection rule, where the UE is an aerial UE and the collection rule is based on an altitude condition for the UE, and transmit the report to the network entity in accordance with the configuration information, where the report indicates the UE-collected data associated with the relational information for the one or more network nodes in response to a satisfaction of the collection rule.

In some examples of the method, apparatuses, and non-transitory computer-readable medium described herein, the altitude condition for the UE includes at least one altitude threshold for an altitude of the UE, and the UE-collected data includes handover data or cell change data collected by the UE in response to the altitude of the UE satisfying the at least one altitude threshold.

In some examples of the method, apparatuses, and non-transitory computer-readable medium described herein, receiving the configuration information may include operations, features, means, or instructions for receiving information indicating an area scope that may be based on the altitude condition, where the UE-collected data includes data collected by the UE in response to a satisfaction of the area scope.

In some examples of the method, apparatuses, and non-transitory computer-readable medium described herein, the configuration information further includes one or more cell indicators, and the UE-collected data includes data collected by the UE for one or more cells associated with the one or more cell indicators.

In some examples of the method, apparatuses, and non-transitory computer-readable medium described herein, the altitude condition for the UE comprises at least one altitude threshold for an altitude of the UE, and the method, apparatuses, and non-transitory computer-readable medium may include further operations, features, means, or instructions for collecting first data associated with one or more first cells of the one or more cells in response to a satisfaction of a first threshold of the at least one altitude threshold.

In some examples of the method, apparatuses, and non-transitory computer-readable medium described herein, the collection rule may be further based on a signal quality condition, the altitude condition including at least one altitude threshold for an altitude of the UE, and the UE-collected data includes data collected by the UE in response to a satisfaction of the signal quality condition and the altitude of the UE satisfying the at least one altitude threshold.

Some examples of the method, apparatuses, and non-transitory computer-readable medium described herein may further include operations, features, means, or instructions for receiving one or more reference signals corresponding to one or more cells, where satisfaction of the signal quality condition includes one or more measures of the one or more reference signals satisfying a signal quality threshold.

Some examples of the method, apparatuses, and non-transitory computer-readable medium described herein may further include operations, features, means, or instructions for detecting an entrance of the UE into a restricted zone, where the UE refrains from collecting data while in the restricted zone and collects the UE-collected data while outside of the restricted zone.

In some examples of the method, apparatuses, and non-transitory computer-readable medium described herein, the UE-collected data includes first data indicating an entrance into the restricted zone, second data indicating an exit from the restricted zone, third data indicating that the UE is within a distance from the restricted zone, or any combination thereof.

In some examples of the method, apparatuses, and non-transitory computer-readable medium described herein, receiving the configuration information may include operations, features, means, or instructions for receiving cell report configuration information instructing the UE to collect cell data associated with one or more cells in response to a satisfaction of the altitude condition, and transmitting the report includes transmitting a cell report including the cell data associated with the one or more cells.

In some examples of the method, apparatuses, and non-transitory computer-readable medium described herein, the cell data may be included in an ANR table.

In some examples of the method, apparatuses, and non-transitory computer-readable medium described herein, transmitting the report may include operations, features, means, or instructions for transmitting UE characteristic data associated with the UE, altitude data associated with the UE, detected aerial UE density data, or any combination thereof.

In some examples of the method, apparatuses, and non-transitory computer-readable medium described herein, the report may be a random access report (RA report), a connection establishment failure (CEF) report, a RLF report, a SHR, a SPR, or a report including secondary cell group (SCG) failure information.

In some examples of the method, apparatuses, and non-transitory computer-readable medium described herein, the UE-collected data is logged data, and the method, apparatuses, and non-transitory computer-readable medium may further include operations, features, means, or instructions for transmitting an availability indication to the network entity indicating that the logged data may be available and receiving a request for the logged data based on the availability indication, where transmitting the report to the network entity may be based on receiving the request for the logged data.

A method for wireless communications by a network entity is described. The method may include transmitting, to a UE, configuration information for transmission of a report of UE-collected data associated with relational information for one or more network nodes and a collection rule, where the UE is an aerial UE and the collection rule is based on an altitude condition for the UE, and receiving the report from the UE in accordance with the configuration information, where the report indicates the UE-collected data associated with the relational information for the one or more network nodes in response to a satisfaction of the collection rule.

An apparatus for wireless communications is described. The apparatus may include memory and at least one processor of a network entity, the at least one processor coupled with the memory. The at least one processor may be configured to cause the network entity to transmit, to a UE, configuration information for transmission of a report of UE-collected data associated with relational information for one or more network nodes and a collection rule, where the UE is an aerial UE and the collection rule is based on an altitude condition for the UE, and receive the report from the UE in accordance with the configuration information, where the report indicates the UE-collected data associated with the relational information for the one or more network nodes in response to a satisfaction of the collection rule.

Another apparatus for wireless communications is described. The network entity may include means for transmitting, to a UE, configuration information for transmission of a report of UE-collected data associated with relational information for one or more network nodes and a collection rule, where the UE is an aerial UE and the collection rule is based on an altitude condition for the UE, and means for receiving the report from the UE in accordance with the configuration information, where the report indicates the UE-collected data associated with the relational information for the one or more network nodes in response to a satisfaction of the collection rule.

A non-transitory computer-readable medium storing code is described. The code may include instructions executable by one or more processors to transmit, to a UE, configuration information for transmission of a report of UE-collected data associated with relational information for one or more network nodes and a collection rule, where the UE is an aerial UE and the collection rule is based on an altitude condition for the UE, and receive the report from the UE in accordance with the configuration information, where the report indicates the UE-collected data associated with the relational information for the one or more network nodes in response to a satisfaction of the collection rule.

In some examples of the method, apparatuses, and non-transitory computer-readable medium described herein, the altitude condition for the UE includes at least one altitude threshold for an altitude of the UE, and the UE-collected data includes handover data or cell change data collected by the UE in response to the altitude of the UE satisfying the at least one altitude threshold.

In some examples of the method, apparatuses, and non-transitory computer-readable medium described herein, transmitting the configuration information may include operations, features, means, or instructions for transmitting information indicating an area scope that may be based on the altitude condition, where the UE-collected data includes data collected by the UE in response to a satisfaction of the area scope.

In some examples of the method, apparatuses, and non-transitory computer-readable medium described herein, the configuration information further includes one or more cell indicators and the UE-collected data includes data collected by the UE for one or more cells associated with the one or more cell indicators.

In some examples of the method, apparatuses, and non-transitory computer-readable medium described herein, the altitude condition for the UE includes at least one altitude threshold for an altitude of the UE.

In some examples of the method, apparatuses, and non-transitory computer-readable medium described herein, the collection rule may be further based on a signal quality condition, the altitude condition including at least one altitude threshold for an altitude of the UE, and the UE-collected data includes data collected by the UE in response to a satisfaction of the signal quality condition and the altitude of the UE satisfying the at least one altitude threshold.

In some examples of the method, apparatuses, and non-transitory computer-readable medium described herein, receiving the report may include operations, features, means, or instructions for receiving data indicating one or more reference signals corresponding to one or more cells, where the data indicating one or more reference signals may be collected by the UE in response to satisfaction of the signal quality condition that includes one or more measures of the one or more reference signals satisfying a signal quality threshold.

In some examples of the method, apparatuses, and non-transitory computer-readable medium described herein, the UE-collected data lacks data associated with a restricted zone and includes data associated with one or more areas outside of the restricted zone.

In some examples of the method, apparatuses, and non-transitory computer-readable medium described herein, the UE-collected data includes first data indicating an entrance into the restricted zone, second data indicating an exit from the restricted zone, third data indicating that the UE is within a distance from the restricted zone, or any combination thereof.

In some examples of the method, apparatuses, and non-transitory computer-readable medium described herein, transmitting the configuration information may include operations, features, means, or instructions for transmitting cell report configuration information instructing the UE to collect cell data associated with one or more cells in response to a satisfaction of the altitude condition, and receiving the report includes receiving a cell report including the cell data associated with the one or more cells.

In some examples of the method, apparatuses, and non-transitory computer-readable medium described herein, the cell data may be included in an ANR table.

In some examples of the method, apparatuses, and non-transitory computer-readable medium described herein, receiving the report may include operations, features, means, or instructions for receiving UE characteristic data associated with the UE, altitude data associated with the UE, detected aerial UE density data, or any combination thereof.

In some examples of the method, apparatuses, and non-transitory computer-readable medium described herein, the report may be a RA report, a CEF report, a RLF report, a SHR, a SPR, or a report including SCG failure information.

In some examples of the method, apparatuses, and non-transitory computer-readable medium described herein, the UE-collected data is logged data, and the method, apparatuses, and non-transitory computer-readable medium may further include operations, features, means, or instructions for receiving an availability indication from the UE indicating that the logged data may be available and transmitting a request for the logged data based on the availability indication, where receiving the report from the UE may be based on transmitting the request for the logged data.

### BRIEF DESCRIPTION OF THE DRAWINGS

FIG. 1 shows an example of a wireless communication system that supports reporting enhancements for user equipments (UEs) in accordance with one or more aspects of the present disclosure.

FIG. 2 shows an example of a wireless communication system that supports reporting enhancements for UEs in accordance with one or more aspects of the present disclosure.

FIG. 3 shows an example of a wireless communication system for altitude-based reporting that supports reporting enhancements for UEs in accordance with one or more aspects of the present disclosure.

FIG. 4 shows an example of a wireless communication system for aerial UE data collection that supports reporting enhancements for UEs in accordance with one or more aspects of the present disclosure.

FIG. 5 shows an example of a process flow that supports reporting enhancements for UEs in accordance with one or more aspects of the present disclosure.

FIGS. 6 and 7 show block diagrams of devices that support reporting enhancements for UEs in accordance with one or more aspects of the present disclosure.

FIG. 8 shows a block diagram of a communications manager that supports reporting enhancements for UEs in accordance with one or more aspects of the present disclosure.

FIG. 9 shows a diagram of a system including a device that supports reporting enhancements for UEs in accordance with one or more aspects of the present disclosure.

FIGS. 10 and 11 show block diagrams of devices that support reporting enhancements for UEs in accordance with one or more aspects of the present disclosure.

FIG. 12 shows a block diagram of a communications manager that supports reporting enhancements for UEs in accordance with one or more aspects of the present disclosure.

FIG. 13 shows a diagram of a system including a device that supports reporting enhancements for UEs in accordance with one or more aspects of the present disclosure.

FIGS. 14 through 17 show flowcharts illustrating methods that support reporting enhancements for UEs in accordance with one or more aspects of the present disclosure.

### DETAILED DESCRIPTION

Some wireless communication systems may support aerial user equipments (UEs), which may be devices capable of flying or maneuvering through the air. Such aerial UEs may be referred to as unmanned aerial vehicles or uncrewed aerial vehicles (UAVs) or drones. In some cases, dedicated spectrum may be available for aerial UEs (e.g., in a UAV specific cellular network). In addition to, or alternatively to, cases where dedicated spectrum of a UAV-specific network is available, aerial UEs may operate in traditional cellular spectrum (e.g., using 4G or 5G communications). In some cases, signals from network entities may not be as strong for an aerial UE in an aerial state relative to a UE at ground level at a same location. For example, network entities configured for terrestrial communications may have antenna panels that are directed toward ground level and are thus not specifically directed toward higher elevations above ground level. In such cases, the main lobes of the antenna panels may be directed toward relatively low altitudes or heights, but side lobes may be generated at higher altitudes or heights. However, such side lobes (and some portions of main lobes) may have relatively high variability in signal strength at different heights and at various different locations relative to the network entity at such different heights. Such variable signal strength may result in less reliable or intermittent coverage for aerial UEs.

Coverage maps may be used by network operators for network management. Coverage maps may be generated based on measurements from different locations within coverage areas of network entities. The network operator may use the measurements to identify coverage holes, weak coverage, pilot pollution, overshoot coverage, and to provide cell boundary mapping. In some approaches, measurements for coverage maps may be generated using minimization of drive test (MDT) procedures in which a UE logs cell measurements of a serving cell and neighbor cells while in idle mode, and reports the cell measurements to the serving cell. However, such MDT procedures have been designed with terrestrial-based UEs in mind, and may not work well for UAVs or aerial UEs because cell coverage changes significantly as a UE's altitude changes. Also, having aerial UEs provide MDT reports based on measurements obtained while in an aerial state may result in measurements that conflict with those provided by UEs that are on the ground (e.g., due to different signal strengths from main lobes and side lobes as height/altitude changes).

In some approaches, MDT reports (e.g., immediate and logged MDT reports) may indicate characteristics of UE types (e.g., UE types with directional antenna(s), with a car mounted antenna, among other examples), height information (to create a height-specific coverage map, for instance), detected aerial UE density, or an indication that measurements are taken by a UE in an aerial state. Some approaches may provide limited data (e.g., signal strength measurements) or may lack aerial UE events for data collection.

Some examples of the techniques described herein relate to methods, systems, devices, and apparatuses that support reporting enhancements for UEs. An aerial UE may be configured to collect data (for reports, for instance) based on aerial UE-specific events or based on a height-dependent area scope. For example, self-organizing network (SON) or MDT reports may be enhanced for aerial UEs. In some approaches, aerial UE events or a height-specific area scope may be utilized to trigger the collection of logged MDT data to enhance coverage and capacity at a specific altitude. MDT data may be collected when an altitude condition is met, when a signal quality condition is met, or when the UE is located outside of a restricted zone. In some approaches, an aerial UE may collect data for height-specific automatic neighbor relation (ANR) tables. For instance, a network entity may configure a UE to report cell global identities (CGIs) of cells detected at a specific altitude or within an altitude range. Additional data types may be provided in reports, such as a UE type indication in a SON report with UE altitude or UE characteristics. For example, successful handover reports (SHRs) or successful primary secondary cell (PSCell) change reports (SPRs) may be generated by an aerial UE using one or more data collection triggers (e.g., when a UE's altitude satisfies an altitude threshold). Some reports (e.g., random access reports, radio link failure (RLF) reports, SHRs, SPRs, among other examples) may be enhanced to include data indicating an altitude of the UE, characteristics of the UE (e.g., antenna type, antenna direction, antenna mounting), or a detected aerial UE density in the UE vicinity at the time of measurement.

Various aspects of the present disclosure provide techniques to enhance reporting for aerial UEs, which may be beneficial to enhance communications efficiency and reliability, such as through identification of regions in which cell changes (e.g., handovers) are more likely to be successful, identification of regions where a radio link failure is more likely to occur, or provision of SON data that varies in accordance with altitude, to name a few examples.

Aspects of the disclosure are initially described in the context of wireless communication systems. Aspects of the disclosure are further illustrated in the context of a process flow diagram. Aspects of the disclosure are further illustrated by and described with reference to apparatus diagrams, system diagrams, and flowcharts that relate to reporting enhancements for UEs.

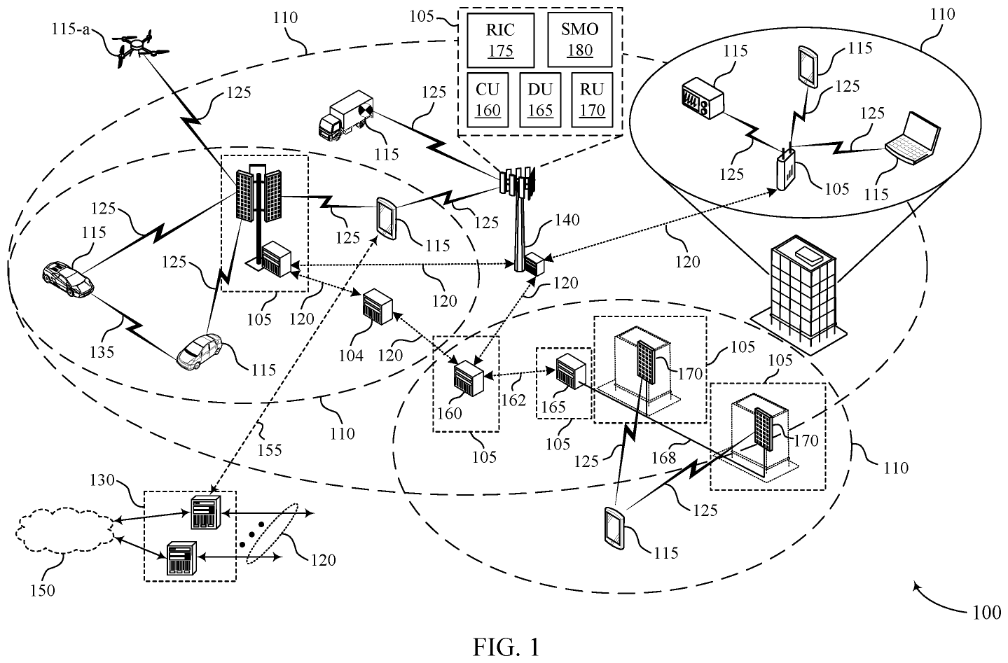

FIG. 1 shows an example of a wireless communication system 100 that supports reporting enhancements for UEs in accordance with one or more aspects of the present disclosure. The wireless communication system 100 may include one or more network entities 105, one or more UEs 115, and a core network 130. In some examples, the wireless communication system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communication system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communication system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communication system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communication systems (e.g., wireless communication system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support reporting enhancements for UEs as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communication system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communication system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communication system 100 (e.g., the network entities 105, the UEs 115, or both) may have hardware configurations that support communications using a particular carrier bandwidth or may be configurable to support communications using one of a set of carrier bandwidths. In some examples, the wireless communication system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communication systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communication system 100 and may be referred to as a transmission time interval (TTI). In some examples, the TTI duration (e.g., a quantity of symbol periods in a TTI) may be variable. Additionally, or alternatively, the smallest scheduling unit of the wireless communication system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communication system 100 may include, for example, a heterogeneous network in which different types of the network entities 105 provide coverage for various coverage areas 110 using the same or different radio access technologies.

The wireless communication system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communication system 100 may be configured to support ultra-reliable communications or low-latency communications, or various combinations thereof. For example, the wireless communication system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communication system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communication system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communication system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communication system 100 may utilize both licensed and unlicensed RF spectrum bands. For example, the wireless communication system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communication system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some cases, one or more UEs 115, such as an aerial UE 115-a, may be configured to collect data (for reports, for instance) based on aerial UE-specific events or based on a height-dependent area scope. For example, SON or MDT reports may be enhanced for UEs 115. In some approaches, aerial UE events or a height-specific area scope may be utilized to trigger the collection of logged MDT data to enhance coverage and capacity at a specific altitude. MDT data may be collected when an altitude condition is met, when a signal quality condition is met, or when the UE 115 is located outside of a restricted zone. In some approaches, an aerial UE 115-a may collect data for height-specific ANR tables. For instance, a network entity 105 may configure a UE 115 to report CGIs of cells detected at a specific altitude or within an altitude range. Additional data types may be provided in reports, such as a UE type indication in a SON report with UE altitude or UE characteristics. For example, SHRs or SPRs may be generated by an aerial UE 115-a using one or more data collection triggers (e.g., when a UE's altitude satisfies an altitude threshold). Some reports (e.g., random access reports, RLF reports, SHRs, SPRs, among other examples) may be enhanced to include data indicating an altitude of a UE 115 (e.g., aerial UE 115-a), characteristics of the UE 115 (e.g., antenna type, antenna direction, antenna mounting), or a detected UE 115 density in the UE vicinity at the time of measurement.

In some cases, density data collection may be triggered as an immediate MDT report, in which the aerial UE 115-a may obtain measurements of neighboring cells and identify a quantity of other UEs 115 that are detected (e.g., based on broadcast signals or collision avoidance beacons, among other examples). In other cases, the UE 115-a may not obtain neighboring cell measurements, and may provide logged measurements from prior measurement occasions along with an indication of the quantity of detected UEs 115. In further cases, the aerial UE 115-a may not provide measurements, and may simply provide an indication of the quantity of other detected UEs 115.

Some examples of the techniques described herein may enhance data collection for SHRs for UEs 115 (e.g., the aerial UE 115-a). An SHR may be generated to identify one or more conditions during successful handovers (e.g., successful ordinary handovers, successful dual active protocol stack (DAPS) handovers, or successful conditional handovers). For analysis of successful handovers, a UE 115 (e.g., aerial UE 115-a) may generate an SHR based on configuration information received from the network entity 105. The UE 115 may transmit the SHR or make the SHR available to the network entity 105. In some examples, the UE 115 may store the SHR until the SHR is requested by the network entity 105 or for up to a time limit (e.g., 48 hours) after the SHR is recorded. After retrieval of an SHR, the SHR may be analyzed (by a network entity 105, for example) to determine whether to adjust a mobility configuration. For instance, the network entity 105 (e.g., a mobility robustness optimization (MRO) function at the network entity 105) may utilize the SHR to adjust a handover trigger(s) (e.g., handover threshold(s)) to increase a probability of handover success.

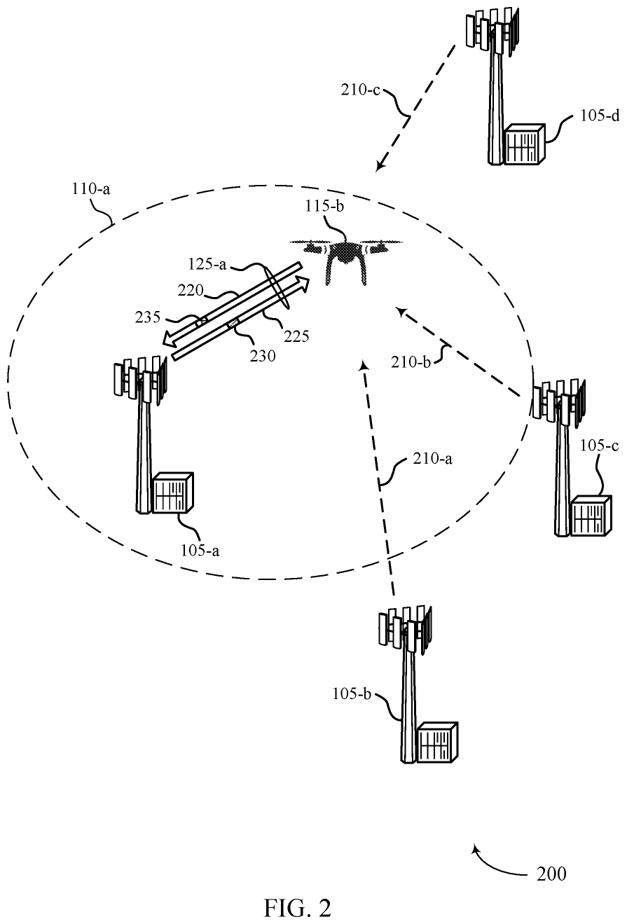

In some approaches, data collected for an SHR may include one or more timer values or may be triggered based on one or more timer values. Some examples of timers include a T310 timer (which may start when an out-of-sync indication is received), a T312 timer (which may start when a radio link failure occurs), and a T304 timer (which may start when a handover command is received). In association with the T310 timer, if a threshold quantity of out-of-sync indications is reached, a radio link failure may occur. In some examples, an SHR may include data indicating one or more successful handovers when a T310 value is greater than a threshold, when a quantity of out-of-sync indications is within a threshold quantity from radio link failure, when a T312 value is greater than a threshold, when a T304 value is greater than a threshold, or when the T304 timer is within a period from expiry (where handover may fail at expiry). More details regarding SHR data collection for an aerial UE 115-a are given with reference to FIG. 2.

Some examples of the techniques described herein may enhance data collection for SPRs for UEs 115 (e.g., the aerial UE 115-a). An SPR may enable observability for detection of a successful PSCell addition or change (e.g., a sub-optimal but successful PSCell addition or change). The UE 115 may collect data for an SPR based on a configuration provided by the network entity 105. For instance, a UE 115 (e.g., an aerial UE 115-a) may collect data for an SPR and may transmit the SPR to the network entity 105. The UE 115 may transmit the SPR or make the SPR available to the network entity 105. In some examples, the UE 115 may store the SPR until the SPR is requested by the network entity 105 or for up to a time limit (e.g., 48 hours) after the SPR is recorded. After retrieval of an SPR, the SPR may be analyzed (by a network entity 105, for example) to determine whether to adjust a mobility configuration. For instance, the network entity 105 (e.g., an MRO function at a network entity 105) may utilize the SPR to adjust a cell change trigger(s) (e.g., cell change threshold(s)) to increase a probability of cell change success.

In some approaches, data collected for an SPR may include one or more timer values or may be triggered based on one or more timer values. Some examples of timers include a T310 timer for a secondary cell group (SCG), a T312 timer for an SCG, and a T304 timer for an SCG. The T310, T312, or T304 timers for the SCG may operate for the SCG similarly to the timers described herein in relation to handovers. In some examples, an SPR may include data indicating one or more successful cell changes when a T310 value for an SCG is greater than a threshold, when a quantity of out-of-sync indications is within a threshold quantity from radio link failure, when a T312 value for an SCG is greater than a threshold, when a T304 value for an SCG is greater than a threshold, or when the T304 timer for an SCG is within a period from expiry (where a cell change may fail at expiry). More details regarding SPR data collection for an aerial UE 115-a are given with reference to FIG. 2.

FIG. 2 shows an example of a wireless communication system 200 that supports reporting enhancements for UEs in accordance with one or more aspects of the present disclosure. In some examples, wireless communication system 200 may implement aspects of wireless communication system 100. For example, the wireless communication system 200 may include a serving network entity 105-a (which may also be referred to as a serving cell) with coverage area 110-a (e.g., for ground-based coverage), multiple neighboring network entities 105-b through 105-d (which may also be referred to as neighboring cells), and a UE 115-b, which may be examples of network entities 105 and UEs 115 as described herein. The wireless communication system 200 may support multiple radio access technologies including 4G systems such as LTE systems, LTE-A systems, or LTE-A Pro systems; 5G systems, which may be referred to as NR systems; sidelink communications, which may be referred to as PC5 communications; a UAV-specific cellular network; or any combinations thereof.

In the example of FIG. 2, an aerial UE 115-b may establish a communication link 125-a (e.g., may enter an RRC connected mode or may establish Uu connectivity in a NR communications network, among other examples) with a serving cell at network entity 105-a. The communication link 125-a may be an example of a communication link 125 described with respect to FIG. 1. The network entity 105-a and the aerial UE 115-b may communicate with the network entity 105-a via the communication link 125-a to support different applications (e.g., video, remote command and control (C2), among other examples). The communication link 125-a may include a bi-directional link that enables both uplink and downlink network communications. For example, the aerial UE 115-b may transmit one or more uplink transmissions 220, such as uplink control signals or uplink data signals, to the network entity 105-a using the communication link 125-a, and the network entity 105-a may transmit one or more downlink transmissions 225, such as downlink control signals or downlink data signals, to the aerial UE 115-b using the communication link 125-a.

The aerial UE 115-b, in some cases, may also establish one or more other connections (e.g., a PC5 connection) with another aerial UE, which may support various applications. Examples of such applications include user-to-everything (U2X) detect and avoid (U2X-DAA) applications, and other applications that may be used for collision control (e.g., using broadcast messages). In some examples, the aerial UE 115-b may also interact with a regulatory authority or service for identification and other purposes. As an example, the aerial UE 115-b may interact with the regulatory authority or service for U2X identification (ID) (e.g., remote identification), and may identify or receive flight information (e.g., using broadcast messages), may establish a remote C2 connection, and the like.

The network entity 105-a may transmit configuration information 230 to the aerial UE 115-b. The configuration information 230 may configure the aerial UE 115-b for transmission of a report 235 of UE-collected data associated with relational information for one or more network nodes (e.g., one or more of the aerial UE 115-b or the network entities 105) and a collection rule. For example, the aerial UE 115-b may collect data based on a collection rule to generate a report 235. The aerial UE 115-b may transmit the report 235 to the network entity 105-a.

The report 235 may be associated with relational information for one or more network nodes. As used herein, relational information is information that indicates an aspect of a relationship between network nodes (e.g., between the aerial UE 115-b and one or more of the network entities 105-a, 105-b, 105-c, 105-d, or between two or more of the network entities 105-a, 105-b, 105-c, 105-d). For instance, relational information may indicate a relationship between network nodes for a communication procedure (e.g., handover, cell change, link establishment, or cell group interaction, among other examples). Relational information may indicate source and target nodes for a handover or cell change, may indicate the aerial UE 115-b engaging in a random access procedure with a network entity 105, may indicate the aerial UE 115-b establishing a link or detecting a link failure with a network entity 105, may indicate a specified group of cells for measurement, or may indicate the aerial UE 115-b and a network entity 105 that are prohibited from communicating in a restricted zone, among other examples. In some approaches, data for the report 235 may indicate relational information or collection of data for the report 235 may be based on relational information. Examples of the report 235 may include an SHR, an SPR, a random access report (RA report), a connection establishment failure (CEF) report, a RLF report, or a report including SCG failure information. In some examples, a report 235 may include an MDT report associated with a configured area scope (e.g., a set of cells specified in the configuration information 230) based on an altitude condition or an MDT report associated with a configured restricted zone based on an altitude condition. In some examples, the data for the report associated with relational information may include data in addition to, or alternatively from, one or more signal strength measurements (e.g., reference signal received power (RSRP), reference signal received quality (RSRQ), received signal code power (RSCP), received energy per chip (Ec) of a pilot channel divided by total noise power density (No) (Ec/No), a measured received signal level (Rxlev) of one or more cells, a pilot Pn phase and pilot strength for one or more cells, or a received signal strength indicator (RSSI), among other examples).

A collection rule may be one or more criteria to trigger collection of data (by the aerial UE 115-a) for a report. The collection rule may be based on an altitude condition for collection of data for the report. An altitude condition may specify an altitude or an altitude range to trigger collection of data. For example, an altitude condition may specify a minimum altitude above which the aerial UE 115-a may collect data, may specific a maximum altitude under which the aerial UE 115-a may collect data, or an altitude range within which the aerial UE 115-a may collect data. In some examples, the altitude condition may be indicated in the configuration information 230. For instance, the configuration information 230 may include an explicit or implicit indicator of the altitude condition. In some examples, the configuration information 230 may instruct the aerial UE 115-b to collect data for the report 235 for a specific set of cells for which data is to be collected when the altitude condition is satisfied.

In some examples, the aerial UE 115-b may detect an altitude of the aerial UE 115-b or may receive information indicating an altitude of the aerial UE 115-b. For instance, the aerial UE 115-b may utilize global positioning system (GPS) data to determine the altitude of the aerial UE 115-b. In some examples, the aerial UE 115-b may determine whether the altitude condition is satisfied by determining whether the altitude of the aerial UE 115-b is above an altitude threshold, is below an altitude threshold, or is within an altitude range.

The aerial UE 115-b may collect the data when the collection rule (e.g., altitude condition) is satisfied. Examples of UE-collected data may include a handover success or failure event, a PSCell change or addition success or failure event, whether a random access procedure of the aerial UE 115-b with a network entity 105 was successful, whether connection establishment of the aerial UE 115-b with a network entity 105 failed, whether a radio link between the aerial UE 115-b and a network entity 105 failed, whether communication with a cell group failed, measurements of signals (e.g., signals 210-a, 210-b, 210-c) of a specified set of cells, or data collected outside of a restricted zone. The aerial UE 115-b may utilize the collected data to generate the report 235.

The aerial UE 115-b may transmit the report 235 to the network entity 105-b in accordance with the configuration information 230. The report 235 may indicate the data collected by the aerial UE 115-b associated with the relational information for the one or more network nodes in response to the satisfaction of the collection rule.

In some examples, the collection rule may include one or more conditions (e.g., triggers) for the collection of data for an SHR or SPR. In some approaches, the altitude condition for collection of the data may include one or more altitude thresholds for an altitude of the aerial UE 115-b, and the data for the report 235 may include handover data or cell change data collected by the aerial UE 115-b in response to the altitude of the aerial UE 115-b satisfying the altitude threshold(s). For instance, the altitude condition may include a minimum threshold, a maximum threshold, an altitude threshold range, multiple thresholds for collection of data at different altitudes, or any combination thereof.

In some examples, the aerial UE 115-b may perform altitude-based reporting based on the collection rule, where the aerial UE 115-b has crossed a network-configured altitude threshold. For instance, the collection rule may enable altitude-dependent configurations that apply to specific altitude regions, interference detection based on measurement reporting that is triggered when a configured quantity of cells (e.g., greater than one) fulfills the collection rule concurrently, signaling of flight path information from the aerial UE 115-b to a next generation radio access network (NG-RAN) and from a source network entity to a target network entity during handover, or location information reporting (e.g., horizontal velocity or vertical velocity of the aerial UE 115-b).

In some approaches, the aerial UE 115-b may collect SHR or SPR statistics when the aerial UE 115-b altitude satisfies the collection rule. The collection rule (e.g., altitude condition or altitude threshold(s)) may help to collect more useful data, as more handover near-failures (e.g., handovers occurring within a threshold quantity of out-of-sync indications or within a threshold period from a timer expiry indicating a handover failure) may occur when the aerial UE 115-b is beyond an altitude and when the radio conditions are relatively poor.

Some aspects of the techniques described herein may include logged MDT enhancements for aerial UEs (e.g., the aerial UE 115-b). For example, receiving the configuration information 230 may include receiving information indicating an area scope that is based on the altitude condition, and the data for the report 235 may include data collected by the aerial UE 115-b in response to a satisfaction of the area scope.

The area scope may indicate a region (e.g., a spatial region, geographical area, latitude and longitude-bounded area, among other examples), for the collection of data from one or more cells, where the altitude condition may provide an altitude boundary of the region. For example, the configuration information 230 may include one or more cell indicators, and the data for the report 235 may include data collected by the aerial UE 115-b for one or more cells associated with the one or more cell indicators. In some aspects, the altitude condition for collection of the data may include one or more altitude thresholds for an altitude of the aerial UE 115-b, where the aerial UE 115-b may collect first data associated with one or more first cells of the one or more cells in response to a satisfaction of a first threshold of the one or more altitude thresholds. For example, the aerial UE 115-b may be configured with an altitude-dependent area scope in a logged MDT configuration, where the aerial UE 115-b collects logged MDT data for the network entity 105-a and the network entity 105-b (e.g., cells 1 and 2) if the aerial UE 115-b altitude is less than a first altitude threshold or the aerial UE 115-b collects logged MDT data for the network entity 105-a, the network entity 105-b, the network entity 105-c, and the network entity 105-d (e.g., cells 1, 2, 3, and 4) if the aerial UE 115-b altitude is between the first altitude threshold and a second altitude threshold.

In some aspects, logged MDT may be collected based on the altitude condition of the collection rule. For example, the aerial UE 115-b may collect MDT data for one or more cells when the altitude of the aerial UE 115-b is greater than an altitude threshold or is less than an altitude threshold. In some cases, MDT data collected by the aerial UE 115-b may include a physical cell identity (PCID) of a logged cell, carrier frequency, RSRP, RSRQ, RSCP, Ec/No, Rxlev of one or more cells, a pilot Pn phase and pilot strength for one or more cells, an RSSI and round trip time (RTT) for wireless local area network (WLAN) access points (APs), an RSSI for Bluetooth Beacons, or any combinations thereof.

In some examples, the collection rule may be based on a signal quality condition, and the altitude condition may include one or more altitude thresholds for an altitude of the aerial UE 115-b. The data for the report 235 may include data collected by the aerial UE 115-b in response to a satisfaction of the signal quality condition and the altitude of the aerial UE 115-b satisfying the one or more altitude thresholds. In some aspects, the aerial UE 115-b may receive one or more reference signals (where reference signals may be examples of the signals 210-a, 210-b, and 210-c shown in FIG. 2) corresponding to one or more cells, where satisfaction of the signal quality condition may include one or more measures of the one or more reference signals satisfying a signal quality threshold. For instance, the aerial UE 115-b may collect data (e.g., MDT data) when the altitude condition and an RSRP threshold condition, an RSRQ threshold condition, a signal-to-interference noise ratio (SINR) threshold condition, or an “OutofCoverage” condition is satisfied (e.g., if an “OutofCoverage” event is detected or occurs to a threshold period of time). In some examples, the aerial UE 115-b may collect data (e.g., MDT data) when a measure of a reference signal (e.g., RSRP) of a quantity (e.g., at least N) neighbor cells satisfy the signal quality threshold (e.g., greater or lesser than a threshold).

Some examples of the techniques described herein relate to data collection relative to one or more restricted zones. Collection of logged data (e.g., MDT data) may be based on whether the aerial UE 115-b is located within a restricted zone. Examples of a restricted zone may include a “no-transmit zone” or a “no-fly zone.” A no-transmit zone may be established for geofencing or regulatory purposes. In a no-transmit zone, the aerial UE 115-b (e.g., a UAV) may not be allowed to transmit beyond a threshold power for a given frequency band. In some examples, the network entity 105-a may send a signal to the aerial UE 115-b indicating a restricted zone (e.g., no-transmit zone or no-fly zone). For instance, a restricted zone may be indicated in terms of a three-dimensional space with a zone identifier via a system information block (SIB), dedicated signaling, configured signaling, or via subscription, among other examples. A no-fly zone may be a region where the aerial UE 115-b travel is prohibited.

In some aspects, the aerial UE 115-b may detect an entrance of the aerial UE 115-b into a restricted zone. For example, the aerial UE 115-b may utilize GPS data or other positioning data to determine if the aerial UE 115-b has entered a restricted zone indicated by the network entity 105-a. The aerial UE 115-b may refrain from collecting data while in the restricted zone, and may collect the data for the report 235 while outside of the restricted zone. For example, the data for the report 235 may omit data associated with a restricted zone and may include data for the report 235 collected by the aerial UE 115-b while outside of a restricted zone. In some approaches, the data for the report 235 may include first data indicating an entrance into the restricted zone, second data indicating an exit from the restricted zone, third data indicating that the aerial UE 115-b is within a distance from the restricted zone, or any combination thereof. For example, collection of logged MDT data may be controlled in the context of a restricted zone (e.g., no-transmit zone or no-fly zone). The aerial UE 115-b may stop collecting logged MDT data based on entering a no-transmit zone or a no-fly zone and may resume collecting logged MDT data based on exiting a no-transmit zone or a no-fly zone. The aerial UE 115-b may indicate, in a logged MDT report via a flag, that the aerial UE 115-b has entered a no-transmit zone, that the aerial UE 115-b has exited the no-transmit zone, or the zone identifier(s) corresponding to the no-transmit zone or the no-fly zone, or that the aerial UE 115-b is within a threshold distance (e.g., meters) from the no-transmit zone or the no-fly zone.

In some examples, the network entity 105-a may transmit cell report configuration information. For instance, receiving the configuration information 230 may include receiving cell report configuration information instructing the aerial UE 115-b to collect cell data associated with one or more cells in response to a satisfaction of the altitude condition. Transmitting the report 235 may include transmitting a cell report comprising the cell data associated with the one or more cells. For instance, the network entity 105-a may configure the aerial UE 115-b to provide a CGI report when the aerial UE 115-b is located at an altitude or within an altitude range. In some approaches, the cell data may be included in an ANR table. For instance, the aerial UE 115-b may provide the cell data to develop an ANR table (by the aerial UE 115-b or the network entity 105-a) for cells available at an altitude or within an altitude range.

In some aspects, the aerial UE 115-b may enhance one or more reports (e.g., RA report, CEF report, RLF report, SHR, SPR, MDT report, or a report including SCG failure information) with characteristic data associated with the aerial UE 115-b, altitude data associated with the aerial UE 115-b, detected aerial UE density data, or any combination thereof. For example, the report 235 may indicate characteristics of UE types (e.g., UE types with directional antenna(s), with a car mounted antenna, among other examples), height information (to create a height-specific coverage map, for instance), detected aerial UE density, or other information.

The data for the report 235 may logged data in some cases. For logged data, the aerial UE 115-b may collect and store the data. The aerial UE 115-b may transmit an availability indication to the network entity 105-b indicating that the logged data is available. The network entity 105-b may transmit a request for the logged data based on the availability indication. The aerial UE 115-b may transmit the report 235 to the network entity 105-b based on receiving the request for the logged data.

In some cases, as part of a connection establishment for the communication link 125-a, the aerial UE 115-b may provide capability information. For example, the aerial UE 115-b may indicate a capability to collect and report one or more types of data (e.g., whether the aerial UE 115-b is capable of logging and reporting data for a report associated with relational information for one or more network nodes, an SHR, SPR, CGI report, RLF report, RA report, or MDT report for a configured set of cells, among other examples). Based on the capability indication, the network or serving network entity 105-a may configure the aerial UE 115-b for data collection and reporting.

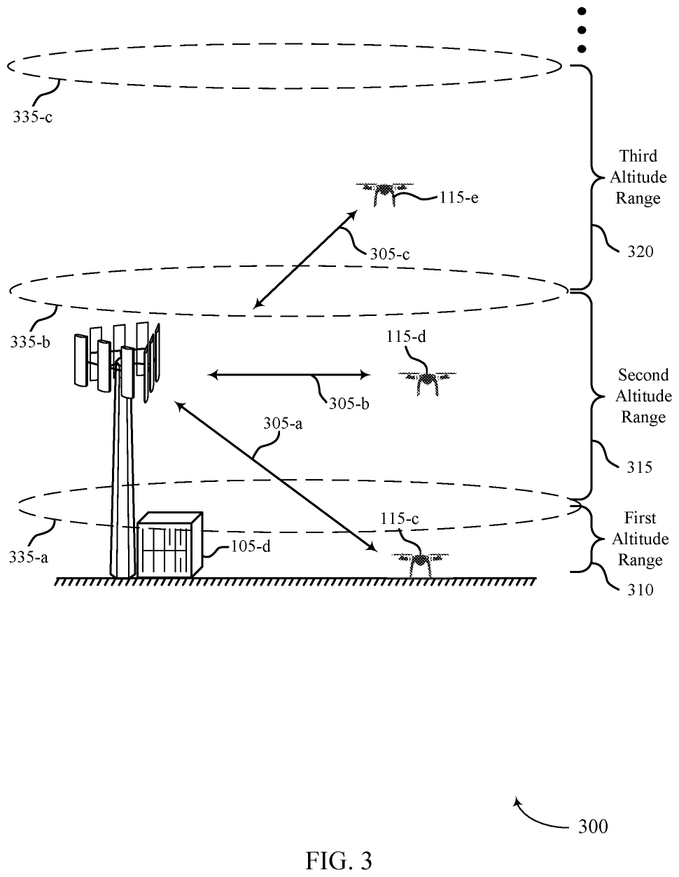

FIG. 3 shows an example of a wireless communication system for altitude-based reporting 300 that supports reporting enhancements for UEs in accordance with one or more aspects of the present disclosure. In some examples, altitude-based reporting 300 may be implemented in aspects of wireless communication systems 100 or 200. For example, a serving network entity 105-d may configure a first aerial UE 115-c, a second aerial UE 115-d, and a third aerial UE 115-e, to provide relational information-associated reports via links 305 (e.g., link 305-a, link 305-b, or link 305-c).

In this example, the relational information-associated reporting may be configured such that each UE 115 may collect data (e.g., data for an SHR, SPR, RLF report, RA report, CGI report, or MDT report for a configured set of cells, among other examples) based on an altitude for multiple regions. In some cases, the UEs 115 may be configured with one or more altitude thresholds 335 that trigger data collection or reporting. For instance, the regions may include a first region in a first altitude range 310 below a first altitude threshold 335-a, data for which may be collected by a first aerial UE 115-c in this example. In some approaches, UE 115 altitude may be inferred based on the altitude thresholds rather than an explicit altitude parameter that is reported by the UE 115. In some approaches, a UE 115 may explicitly indicate altitude in a report. The regions may also include a second region in a second altitude range 315 (e.g., between 50 meters and 60 meters) between the first altitude threshold 335-a and a second altitude threshold 335-b, data for which may be collected by a second aerial UE 115-d. Further, the regions may also include a third region in a third altitude range 320 (e.g., between 60 meters and 75 meters) between the second altitude threshold 335-b and a third altitude threshold 335-c, data for which may be collected by a third aerial UE 115-e. Such altitude-based data collection may allow for adjusting a mobility configuration (e.g., handover or cell change thresholds), identifying UEs 115 for adjustments to transmission power or coverage enhancement, or other techniques.

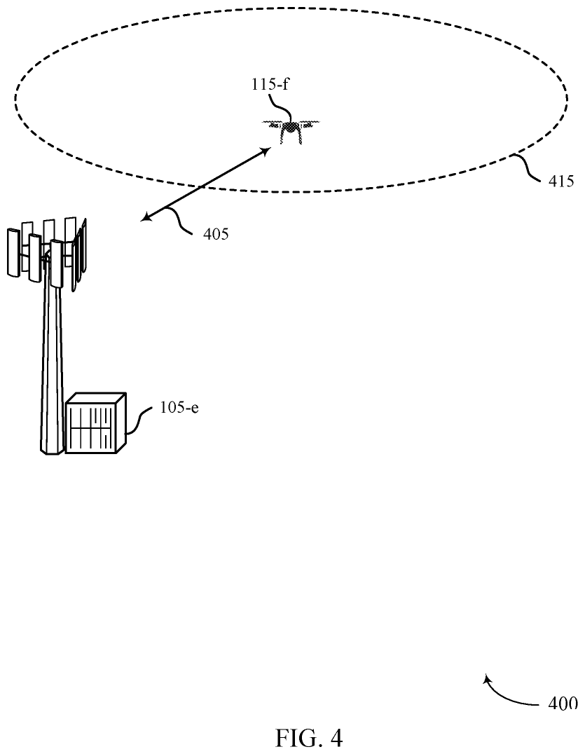

FIG. 4 shows an example of a wireless communication system for aerial UE data collection 400 that supports reporting enhancements for UEs in accordance with one or more aspects of the present disclosure. In some examples, aerial UE data collection 400 may be implemented in aspects of wireless communication systems 100 or 200. For example, a serving network entity 105-e may configure an aerial UE 115-f to provide relational information-associated reports via connection 405 and may additionally, or alternatively, configure the aerial UE 115-f to refrain from collecting data in the restricted zone 415 (e.g., a no-transmit zone or a no-fly zone).

In this example, the network entity 105-e may send a signal (e.g., coordinates, boundaries, or an altitude range) to the aerial UE 115-f indicating the restricted zone 415. In some cases, the radius or a parameter for the restricted zone 415 may be predefined or configured by the network (e.g., via network entity 105-e), which may be provided via RRC, broadcast RRC (e.g., SIB), MAC control element (CE) signaling, or any combinations thereof. Before entering the restricted zone 415 or after exiting the restricted zone 415, the aerial UE 115-f may collect data (e.g., data for an SHR, SPR, RLF report, RA report, CGI report, or MDT report for a configured set of cells, among other examples). In some examples, the aerial UE 115-f may provide an indicator (e.g., flag) in report data indicating that the aerial UE 115-f is within a threshold distance from the restricted zone 415. For instance, the aerial UE 115-f may provide an indicator associated with collected data indicating that the data was collected when the aerial UE 115-f was within the threshold distance from the restricted zone 415. In some examples, the aerial UE 115-f may provide an indicator (e.g., flag) in report data indicating that the aerial UE 115-f has entered or exited the restricted zone 415. For instance, the aerial UE 115-f may provide an indicator associated with collected data indicating that the data collection is being stopped or resumed when the aerial UE 115-f enters or exits the restricted zone 415.

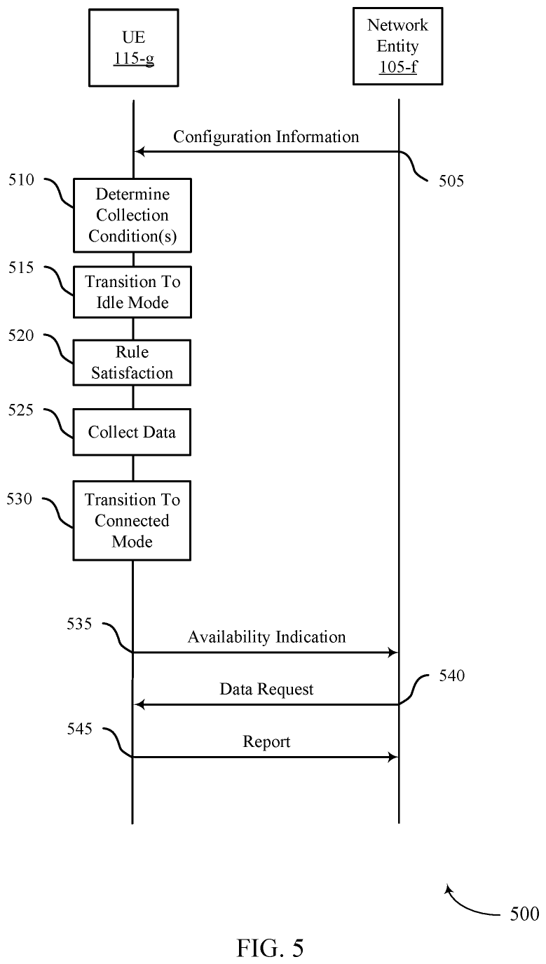

FIG. 5 shows an example of a process flow 500 that supports reporting enhancements for UEs in accordance with one or more aspects of the present disclosure. In some examples, process flow 500 may implement aspects of wireless communication system 100 or 200. The process flow 500 may be implemented by a UE 115-g (e.g., an aerial UE or UAV/drone) and a network entity 105-f as described herein. In the following description of the process flow 500, the communications between the UE 115-g and the network entity 105-f may be transmitted in a different order than the example order shown, or the operations performed by the UE 115-g and network entity 105-f may be performed in different orders or at different times. Some operations may also be omitted from the process flow 500, and other operations may be added to the process flow 500.

In some examples, the operations illustrated in the process flow 500 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 505, the network entity 105-f may transmit configuration information to the UE 115-g for transmission of a report of UE-collected data associated with relational information for one or more network nodes and a collection rule. In some cases, the configuration information may indicate the collection rule (e.g., an altitude condition, one or more altitude thresholds, information indicating an area scope, one or more cell indicators, one or more signal quality conditions, or information indicating a restricted zone, among other examples). In some examples, the configuration information may be transmitted in a LoggedMeasurementConfiguration message. In some examples, the UE 115-g may be in an RRC connected state when the configuration information is received. For instance, the UE 115-g and the network entity 105-f may have established a link previous to the network entity 105-f transmitting the configuration information.

At 510, the UE 115-g may determine one or more collection conditions. For example, the UE 115-g may store one or more aspects of the collection rule (e.g., an altitude condition, one or more altitude thresholds, information indicating an area scope, one or more cell indicators, one or more signal quality conditions, or information indicating a restricted zone, among other examples) to enable the UE 115-g to implement the collection rule.

At 515, the UE 115-g may transition to an idle mode (e.g., based on inactivity of the connection with the network entity 105-f). For instance, the UE 115-g may transition to an RRC idle or RRC inactive state.

At 520, the UE 115-g may detect a satisfaction of the collection rule. For example, the UE 115-g may detect that the UE 115-g has crossed an altitude threshold, that the UE 115-g is within an altitude range, that the UE 115-g has exited a restricted zone, or that one or more signal quality conditions are satisfied, among other examples.

At 525, the UE 115-g may collect data for the report. For example, the UE 115-g may collect handover success or failure data, cell change success or failure data, MDT data for a configured set of cells, RLF failure data, or CGI data, among other examples. The collected data may be stored (e.g., logged). The collected data may be logged data that is collected while the UE 115-g is in the idle mode. In some examples, the data may be stored with UE 115-g altitude data, an indicator that the UE 115-g is within a threshold range of a restricted zone, an indicator that the UE 115-g has exited a restricted zone, or a time stamp, among other examples.

At 530, the UE 115-g may transition to a connected mode. For example, the UE 115-g may transition to an RRC connected mode based on UE 115-g or network entity 105-f (e.g., link) activity.

At 535, the UE 115-g may transmit an availability indication to the network entity 105-f indicating that logged data is available. For example, the UE 115-g may transmit a logMeasAvailable parameter to the network entity 105-f as part of an RRC connection setup complete message.

At 540, the network entity 105-f may transmit a request for the logged data based on the availability indication. For example, the network entity 105-f may send a UEInformationRequest indicating the request for the logged data.

At 545, the UE 115-g may transmit a report to the network entity 105-f. For example, the UE 115-g may transmit an SHR, SPR, RLF report, RA report, CGI report, or MDT report for a configured set of cells, among other examples. The report may be transmitted in response to the request for the logged data.

In some examples, the network entity 105-f may adjust a mobility configuration based on the report. For example, the network entity 105-f may send a configuration message to the UE 115-g to adjust handover or cell change thresholds to increase a probability of handover of cell change success. In some approaches, the network entity 105-f may adjust one or more handover or cell change thresholds, transmission power, or beam directionality based on the report. In some examples, the network entity 105-f may transmit a message to one or more other network entities to adjust transmission power or beam directionality based on the report.

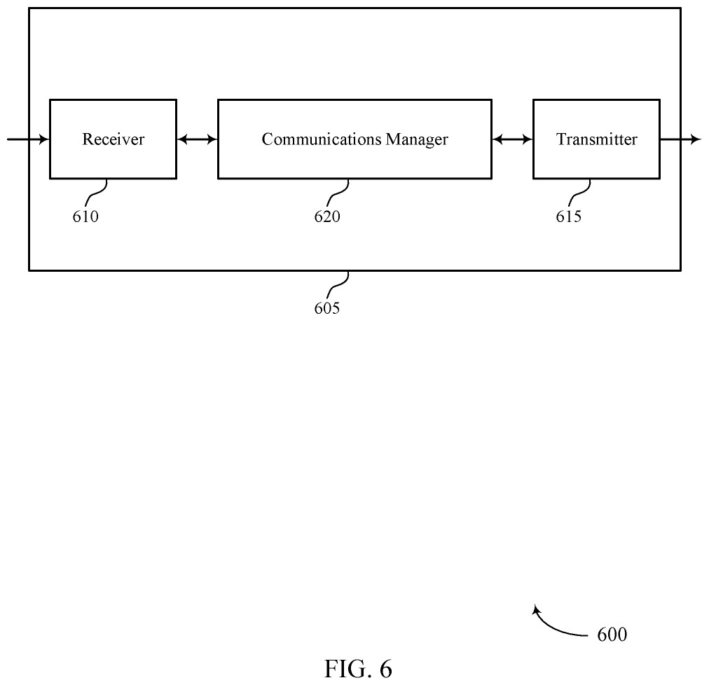

FIG. 6 shows a block diagram 600 of a device 605 that supports reporting enhancements for UEs in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to reporting enhancements for UEs). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to reporting enhancements for UEs). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of reporting enhancements for UEs as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor. If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

For example, the communications manager 620 is capable of, configured to, or operable to support a means for receiving, from a network entity, configuration information for transmission of a report of UE-collected data associated with relational information for one or more network nodes and a collection rule, where the UE is an aerial UE and the collection rule is based on an altitude condition for the UE. The communications manager 620 is capable of, configured to, or operable to support a means for transmitting the report to the network entity in accordance with the configuration information, where the report indicates the UE-collected data associated with the relational information for the one or more network nodes in response to a satisfaction of the collection rule.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, reduced power consumption, or more efficient utilization of communication resources).

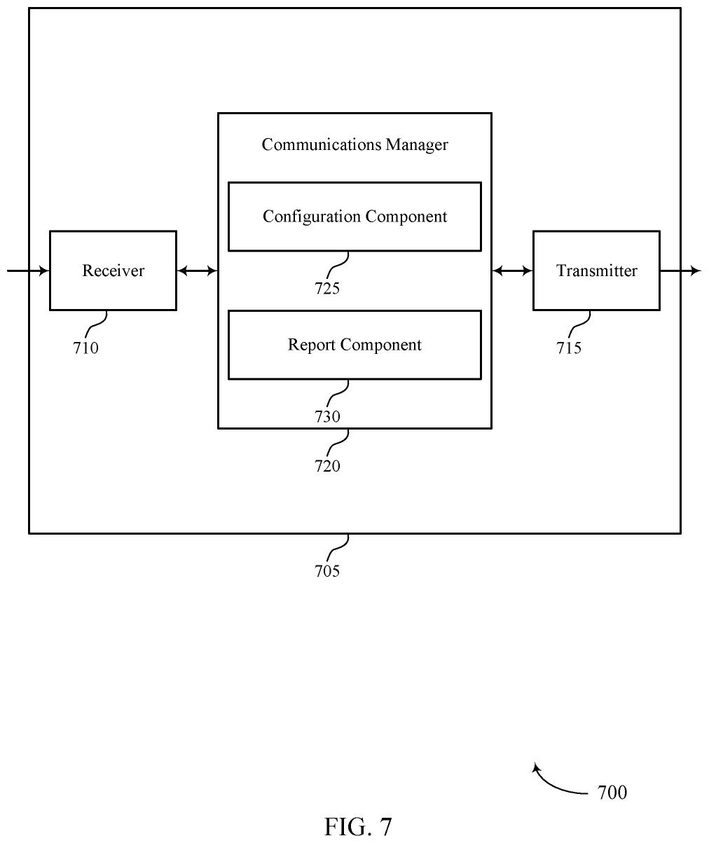

FIG. 7 shows a block diagram 700 of a device 705 that supports reporting enhancements for UEs in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to reporting enhancements for UEs). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to reporting enhancements for UEs). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of reporting enhancements for UEs as described herein. For example, the communications manager 720 may include a configuration component 725 a report component 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The configuration component 725 is capable of, configured to, or operable to support a means for receiving, from a network entity, configuration information for transmission of a report of UE-collected data associated with relational information for one or more network nodes and a collection rule, where the UE is an aerial UE and the collection rule is based on an altitude condition for the UE. The report component 730 is capable of, configured to, or operable to support a means for transmitting the report to the network entity in accordance with the configuration information, where the report indicates the UE-collected data associated with the relational information for the one or more network nodes in response to a satisfaction of the collection rule.

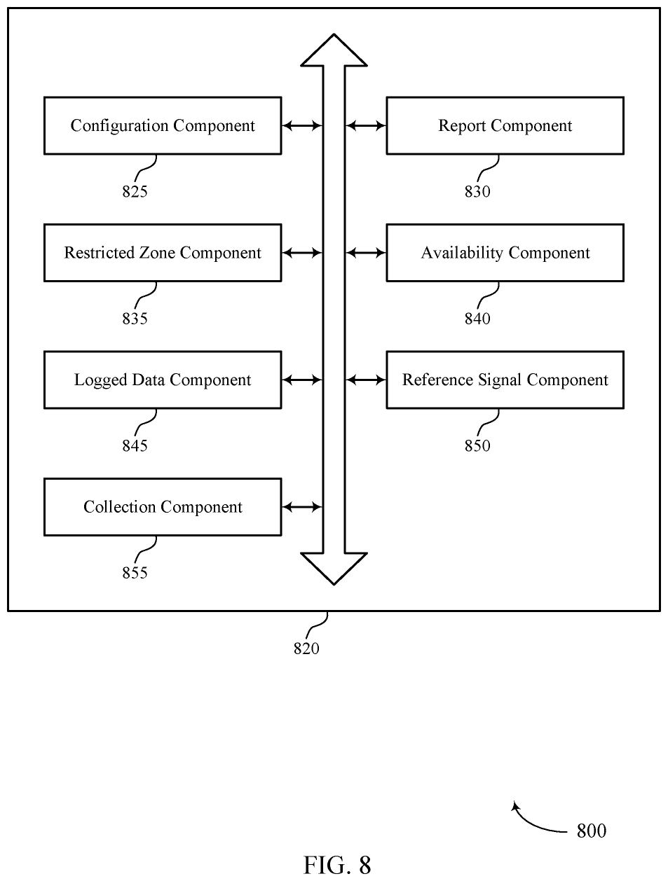

FIG. 8 shows a block diagram 800 of a communications manager 820 that supports reporting enhancements for UEs in accordance with one or more aspects of the present disclosure. The communications manager 820 may be an example of aspects of a communications manager 620, a communications manager 720, or both, as described herein. The communications manager 820, or various components thereof, may be an example of means for performing various aspects of reporting enhancements for UEs as described herein. For example, the communications manager 820 may include a configuration component 825, a report component 830, a restricted zone component 835, an availability component 840, a logged data component 845, a reference signal component 850, a collection component 855, or any combination thereof. Each of these components, or components or subcomponents thereof (e.g., one or more processors, one or more memories), may communicate, directly or indirectly, with one another (e.g., via one or more buses).

The configuration component 825 is capable of, configured to, or operable to support a means for receiving, from a network entity, configuration information for transmission of a report of UE-collected data associated with relational information for one or more network nodes and a collection rule, where the UE is an aerial UE and the collection rule is based on an altitude condition for the UE. The report component 830 is capable of, configured to, or operable to support a means for transmitting the report to the network entity in accordance with the configuration information, where the report indicates the UE-collected data associated with the relational information for the one or more network nodes in response to a satisfaction of the collection rule.

In some examples, the altitude condition for the UE includes at least one altitude threshold for an altitude of the UE, and the UE-collected data includes handover data or cell change data collected by the UE in response to the altitude of the UE satisfying the at least one altitude threshold.

In some examples, to support receiving the configuration information, the configuration component 825 is capable of, configured to, or operable to support a means for receiving information indicating an area scope that is based on the altitude condition, where the UE-collected data includes data collected by the UE in response to a satisfaction of the area scope.

In some examples, the configuration information further includes one or more cell indicators. In some examples, the UE-collected data includes data collected by the UE for one or more cells associated with the one or more cell indicators.

In some examples, the altitude condition for the UE includes at least one altitude threshold for an altitude of the UE, and the collection component 855 is capable of, configured to, or operable to support a means for collecting first data associated with one or more first cells of the one or more cells in response to a satisfaction of a first threshold of the at least one altitude threshold.

In some examples, the collection rule is further based on a signal quality condition, the altitude condition including at least one altitude threshold for an altitude of the UE. In some examples, the UE-collected data includes data collected by the UE in response to a satisfaction of the signal quality condition and the altitude of the UE satisfying the at least one altitude threshold.

In some examples, the reference signal component 850 is capable of, configured to, or operable to support a means for receiving one or more reference signals corresponding to one or more cells, where satisfaction of the signal quality condition includes one or more measures of the one or more reference signals satisfying a signal quality threshold.

In some examples, the restricted zone component 835 is capable of, configured to, or operable to support a means for detecting an entrance of the UE into a restricted zone, where the UE refrains from collecting data while in the restricted zone and collects the UE-collected data while outside of the restricted zone.

In some examples, the UE-collected data includes first data indicating an entrance into the restricted zone, second data indicating an exit from the restricted zone, third data indicating that the UE is within a distance from the restricted zone, or any combination thereof.

In some examples, to support receiving the configuration information, the configuration component 825 is capable of, configured to, or operable to support a means for receiving cell report configuration information instructing the UE to collect cell data associated with one or more cells in response to a satisfaction of the altitude condition, and transmitting the report includes transmitting a cell report including the cell data associated with the one or more cells.

In some examples, the cell data is included in an ANR table.

In some examples, to support transmitting the report, the report component 830 is capable of, configured to, or operable to support a means for transmitting UE characteristic data associated with the UE, altitude data associated with the UE, detected aerial UE density data, or any combination thereof.

In some examples, the report is a RA report, a CEF report, a RLF report, a SHR, a SPR, or a report including SCG failure information.

In some examples, the UE-collected data is logged data, and the availability component 840 is capable of, configured to, or operable to support a means for transmitting an availability indication to the network entity indicating that the logged data is available. In some examples, the logged data component 845 is capable of, configured to, or operable to support a means for receiving a request for the logged data based on the availability indication, where transmitting the report to the network entity is based on receiving the request for the logged data.

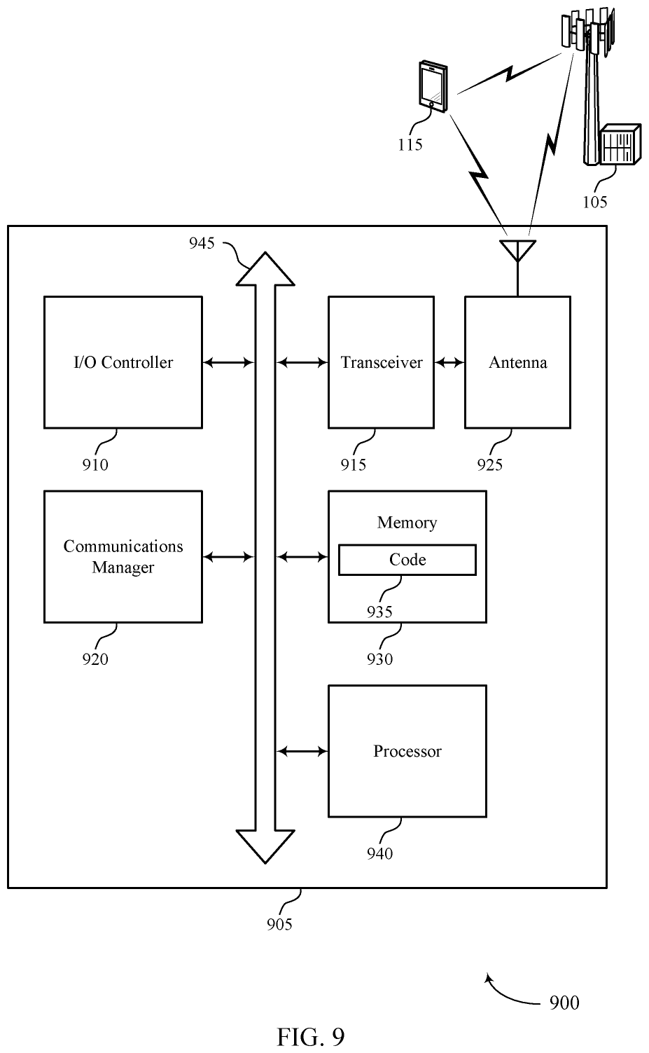

FIG. 9 shows a diagram of a system 900 including a device 905 that supports reporting enhancements for UEs in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable code 935 including instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may contain, among other things, a basic I/O system (BIOS) which may control basic hardware or software operation such as the interaction with peripheral components or devices.

The at least one processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting reporting enhancements for UEs). For example, the device 905 or a component of the device 905 may include at least one processor 940 and at least one memory 930 coupled with or to the at least one processor 940, the at least one processor 940 and at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. As such, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code stored in the at least one memory 930 or otherwise, to perform one or more of the functions described herein.

For example, the communications manager 920 is capable of, configured to, or operable to support a means for receiving, from a network entity, configuration information for transmission of a report of UE-collected data associated with relational information for one or more network nodes and a collection rule, where the UE is an aerial UE and the collection rule is based on an altitude condition for the UE. The communications manager 920 is capable of, configured to, or operable to support a means for transmitting the report to the network entity in accordance with the configuration information, where the report indicates the UE-collected data associated with the relational information for the one or more network nodes in response to a satisfaction of the collection rule.

By including or configuring the communications manager 920 in accordance with examples as described herein, the device 905 may support techniques for improved communication reliability, reduced latency, reduced power consumption, more efficient utilization of communication resources, improved coordination between devices, longer battery life, or improved utilization of processing capability).

In some examples, the communications manager 920 may be configured to perform various operations (e.g., receiving, monitoring, transmitting) using or otherwise in cooperation with the transceiver 915, the one or more antennas 925, or any combination thereof. For example, the communications manager 920 may be configured to receive or transmit messages or other signaling as described herein via the transceiver 915. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of reporting enhancements for UEs as described herein, or the at least one processor 940 and the at least one memory 930 may be otherwise configured to, individually or collectively, perform or support such operations.

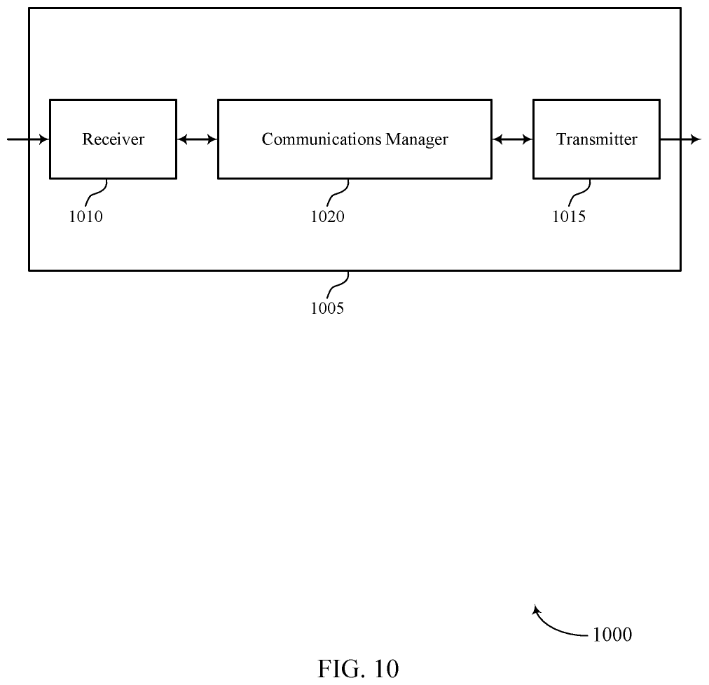

FIG. 10 shows a block diagram 1000 of a device 1005 that supports reporting enhancements for UEs in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of reporting enhancements for UEs as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor. If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

For example, the communications manager 1020 is capable of, configured to, or operable to support a means for transmitting, to a UE, configuration information for transmission of a report of UE-collected data associated with relational information for one or more network nodes and a collection rule, where the UE is an aerial UE and the collection rule is based on an altitude condition for the UE. The communications manager 1020 is capable of, configured to, or operable to support a means for receiving the report from the UE in accordance with the configuration information, where the report indicates the UE-collected data associated with the relational information for the one or more network nodes in response to a satisfaction of the collection rule.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced processing, reduced power consumption, or more efficient utilization of communication resources.

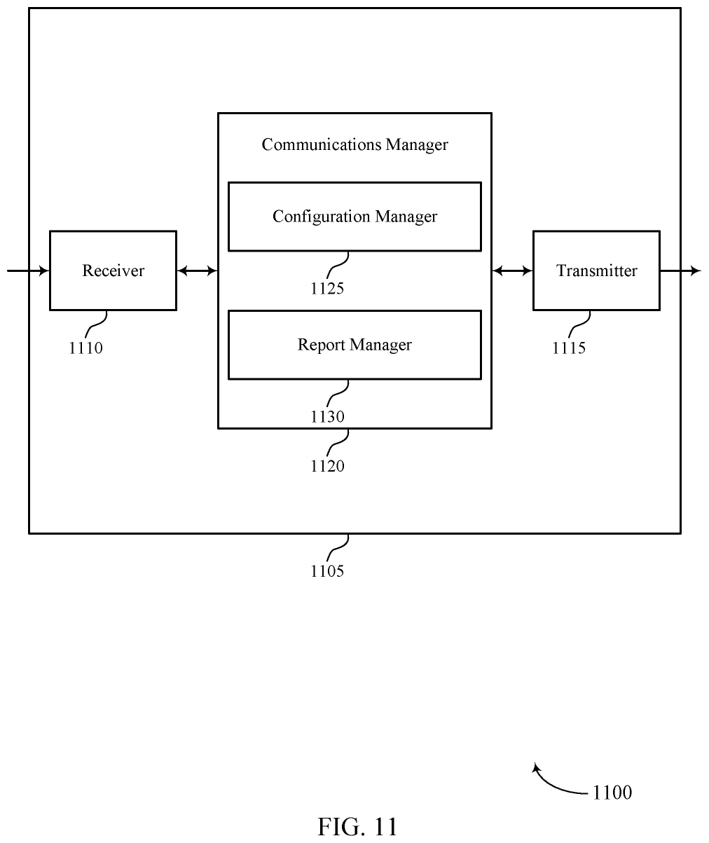

FIG. 11 shows a block diagram 1100 of a device 1105 that supports reporting enhancements for UEs in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of reporting enhancements for UEs as described herein. For example, the communications manager 1120 may include a configuration manager 1125 a report manager 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The configuration manager 1125 is capable of, configured to, or operable to support a means for transmitting, to a UE, configuration information for transmission of a report of UE-collected data associated with relational information for one or more network nodes and a collection rule, where the UE is an aerial UE and the collection rule is based on an altitude condition for the UE. The report manager 1130 is capable of, configured to, or operable to support a means for receiving the report from the UE in accordance with the configuration information, where the report indicates the UE-collected data associated with the relational information for the one or more network nodes in response to a satisfaction of the collection rule.

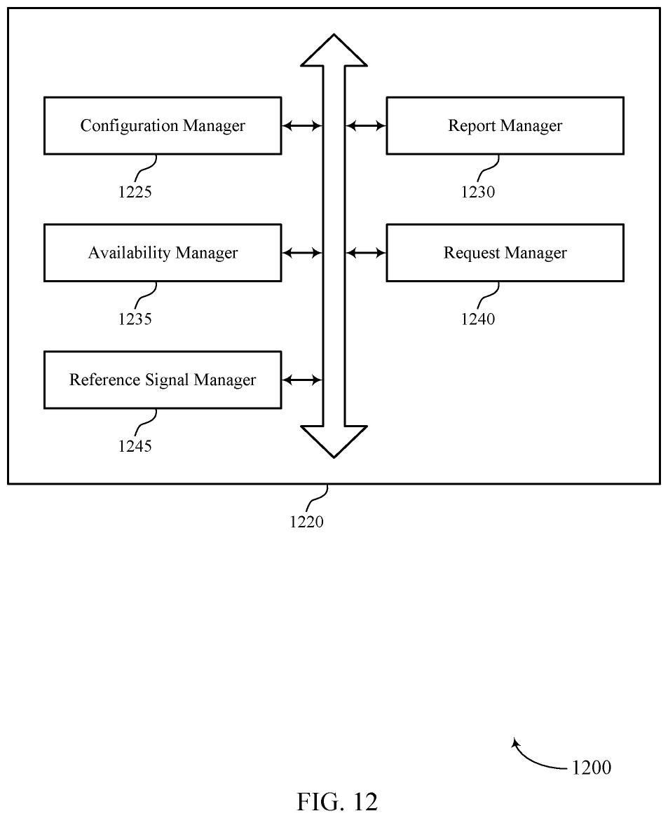

FIG. 12 shows a block diagram 1200 of a communications manager 1220 that supports reporting enhancements for UEs in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of reporting enhancements for UEs as described herein. For example, the communications manager 1220 may include a configuration manager 1225, a report manager 1230, an availability manager 1235, a request manager 1240, a reference signal manager 1245, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The configuration manager 1225 is capable of, configured to, or operable to support a means for transmitting, to a UE, configuration information for transmission of a report of UE-collected data associated with relational information for one or more network nodes and a collection rule, where the UE is an aerial UE and the collection rule is based on an altitude condition for the UE. The report manager 1230 is capable of, configured to, or operable to support a means for receiving the report from the UE in accordance with the configuration information, where the report indicates the UE-collected data associated with the relational information for the one or more network nodes in response to a satisfaction of the collection rule.

In some examples, the altitude condition for the UE includes at least one altitude threshold for an altitude of the UE, and the UE-collected data includes handover data or cell change data collected by the UE in response to the altitude of the UE satisfying the at least one altitude threshold.

In some examples, to support transmitting the configuration information, the configuration manager 1225 is capable of, configured to, or operable to support a means for transmitting information indicating an area scope that is based on the altitude condition, where the UE-collected data includes data collected by the UE in response to a satisfaction of the area scope.

In some examples, the configuration information further includes one or more cell indicators. In some examples, the UE-collected data includes data collected by the UE for one or more cells associated with the one or more cell indicators.

In some examples, the altitude condition the UE includes at least one altitude threshold for an altitude of the UE.

In some examples, the collection rule is further based on a signal quality condition, the altitude condition including at least one altitude threshold for an altitude of the UE. In some examples, the UE-collected data includes data collected by the UE in response to a satisfaction of the signal quality condition and the altitude of the UE satisfying the at least one altitude threshold.

In some examples, to support receiving the report, the reference signal manager 1245 is capable of, configured to, or operable to support a means for receiving data indicating one or more reference signals corresponding to one or more cells, where the data indicating one or more reference signals is collected by the UE in response to satisfaction of the signal quality condition that includes one or more measures of the one or more reference signals satisfying a signal quality threshold.

In some examples, the UE-collected data lacks data associated with a restricted zone and includes data associated with one or more areas outside of the restricted zone.

In some examples, the UE-collected data includes first data indicating an entrance into the restricted zone, second data indicating an exit from the restricted zone, third data indicating that the UE is within a distance from the restricted zone, or any combination thereof.

In some examples, to support transmitting the configuration information, the configuration manager 1225 is capable of, configured to, or operable to support a means for transmitting cell report configuration information instructing the UE to collect cell data associated with one or more cells in response to a satisfaction of the altitude condition, and receiving the report includes receiving a cell report including the cell data associated with the one or more cells.

In some examples, the cell data is included in an ANR table.

In some examples, to support receiving the report, the report manager 1230 is capable of, configured to, or operable to support a means for receiving UE characteristic data associated with the UE, altitude data associated with the UE, detected aerial UE density data, or any combination thereof.

In some examples, the report is a RA report, a CEF report, a RLF report, a SHR, a SPR, or a report including SCG failure information.

In some examples, the UE-collected data is logged data, and the availability manager 1235 is capable of, configured to, or operable to support a means for receiving an availability indication from the UE indicating that the logged data is available. In some examples, the request manager 1240 is capable of, configured to, or operable to support a means for transmitting a request for the logged data based on the availability indication, where receiving the report from the UE is based on transmitting the request for the logged data.

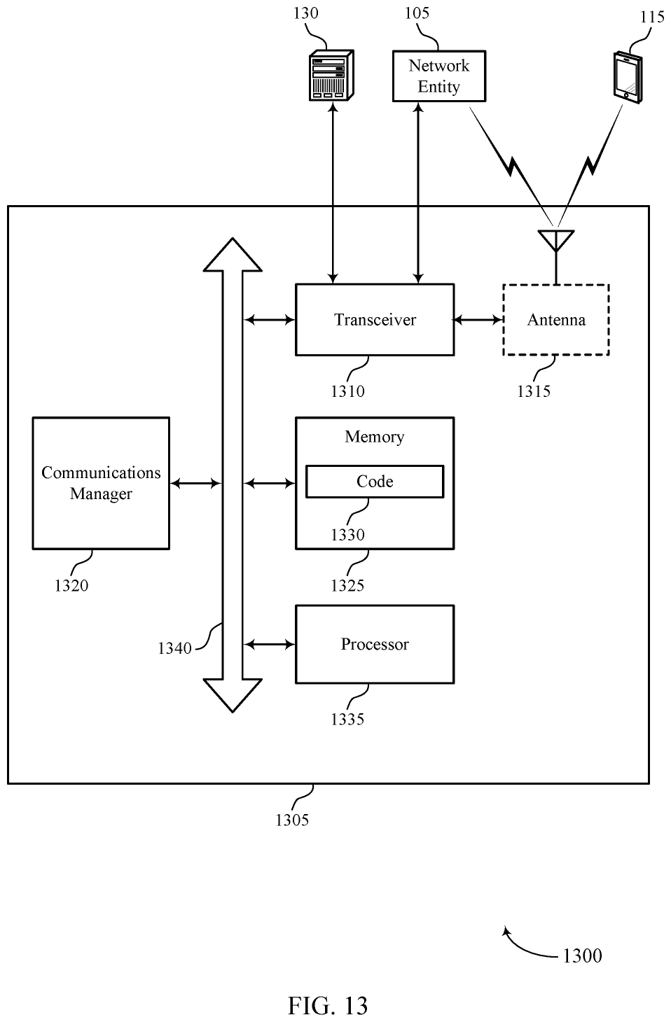

FIG. 13 shows a diagram of a system 1300 including a device 1305 that supports reporting enhancements for UEs in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., a communication link 125, a backhaul communication link 120, a midhaul communication link 162, a fronthaul communication link 168).

The at least one memory 1325 may include RAM, ROM, or any combination thereof. The at least one memory 1325 may store computer-readable, computer-executable code 1330 including instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may contain, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting reporting enhancements for UEs). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325). In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. As such, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105 and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

For example, the communications manager 1320 is capable of, configured to, or operable to support a means for transmitting, to a UE, configuration information for transmission of a report of UE-collected data associated with relational information for one or more network nodes and a collection rule, where the UE is an aerial UE and the collection rule is based on an altitude condition for the UE. The communications manager 1320 is capable of, configured to, or operable to support a means for receiving the report from the UE in accordance with the configuration information, where the report indicates the UE-collected data associated with the relational information for the one or more network nodes in response to a satisfaction of the collection rule.

By including or configuring the communications manager 1320 in accordance with examples as described herein, the device 1305 may support techniques for improved communication reliability, reduced latency, reduced power consumption, more efficient utilization of communication resources, improved coordination between devices, longer battery life, or improved utilization of processing capability.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. For example, the communications manager 1320 may be configured to receive or transmit messages or other signaling as described herein via the transceiver 1310. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of reporting enhancements for UEs as described herein, or the at least one processor 1335 and the at least one memory 1325 may be otherwise configured to, individually or collectively, perform or support such operations.

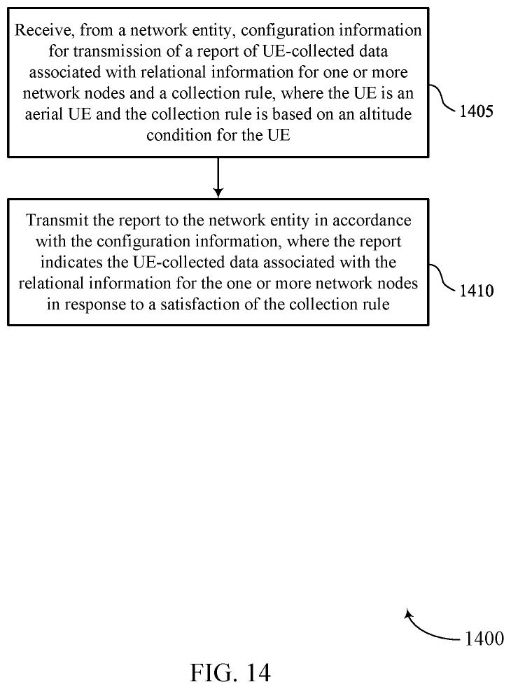

FIG. 14 shows a flowchart illustrating a method 1400 that supports reporting enhancements for UEs in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving, from a network entity, configuration information for transmission of a report of UE-collected data associated with relational information for one or more network nodes and a collection rule, where the UE is an aerial UE and the collection rule is based on an altitude condition for the UE. The operations of block 1405 may be performed in accordance with examples as disclosed herein. In some examples, aspects of the operations of 1405 may be performed by a configuration component 825 as described with reference to FIG. 8. Additionally, or alternatively, means for performing 1405 may, but not necessarily, include, for example, antenna 925, transceiver 915, communications manager 920, memory 930 (including code 935), processor 940, or bus 945.

At 1410, the method may include transmitting the report to the network entity in accordance with the configuration information, where the report indicates the UE-collected data associated with the relational information for the one or more network nodes in response to a satisfaction of the collection rule. The operations of block 1410 may be performed in accordance with examples as disclosed herein. In some examples, aspects of the operations of 1410 may be performed by a report component 830 as described with reference to FIG. 8. Additionally, or alternatively, means for performing 1410 may, but not necessarily, include, for example, antenna 925, transceiver 915, communications manager 920, memory 930 (including code 935), processor 940, or bus 945.

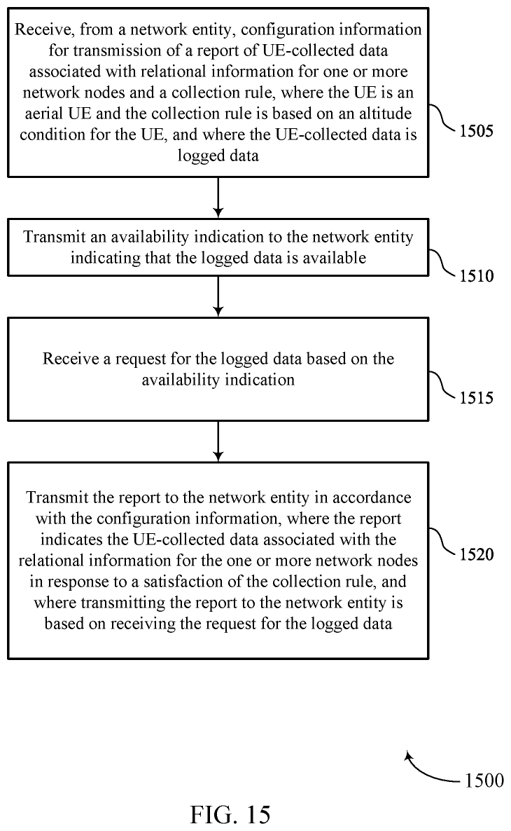

FIG. 15 shows a flowchart illustrating a method 1500 that supports reporting enhancements for UEs in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving, from a network entity, configuration information for transmission of a report of UE-collected data associated with relational information for one or more network nodes and a collection rule, where the UE is an aerial UE and the collection rule is based on an altitude condition for the UE, and where the UE-collected data is logged data. The operations of block 1505 may be performed in accordance with examples as disclosed herein. In some examples, aspects of the operations of 1505 may be performed by a configuration component 825 as described with reference to FIG. 8. Additionally, or alternatively, means for performing 1505 may, but not necessarily, include, for example, antenna 925, transceiver 915, communications manager 920, memory 930 (including code 935), processor 940, or bus 945.

At 1510, the method may include transmitting an availability indication to the network entity indicating that the logged data is available. The operations of block 1510 may be performed in accordance with examples as disclosed herein. In some examples, aspects of the operations of 1510 may be performed by an availability component 840 as described with reference to FIG. 8. Additionally, or alternatively, means for performing 1510 may, but not necessarily, include, for example, antenna 925, transceiver 915, communications manager 920, memory 930 (including code 935), processor 940, or bus 945.

At 1515, the method may include receiving a request for the logged data based on the availability indication. The operations of block 1515 may be performed in accordance with examples as disclosed herein. In some examples, aspects of the operations of 1515 may be performed by a logged data component 845 as described with reference to FIG. 8. Additionally, or alternatively, means for performing 1515 may, but not necessarily, include, for example, antenna 925, transceiver 915, communications manager 920, memory 930 (including code 935), processor 940, or bus 945.

At 1520, the method may include transmitting the report to the network entity in accordance with the configuration information, where the report indicates the UE-collected data associated with the relational information for the one or more network nodes in response to a satisfaction of the collection rule, and where transmitting the report to the network entity is based on receiving the request for the logged data. The operations of block 1520 may be performed in accordance with examples as disclosed herein. In some examples, aspects of the operations of 1520 may be performed by a report component 830 as described with reference to FIG. 8. Additionally, or alternatively, means for performing 1520 may, but not necessarily, include, for example, antenna 925, transceiver 915, communications manager 920, memory 930 (including code 935), processor 940, or bus 945.

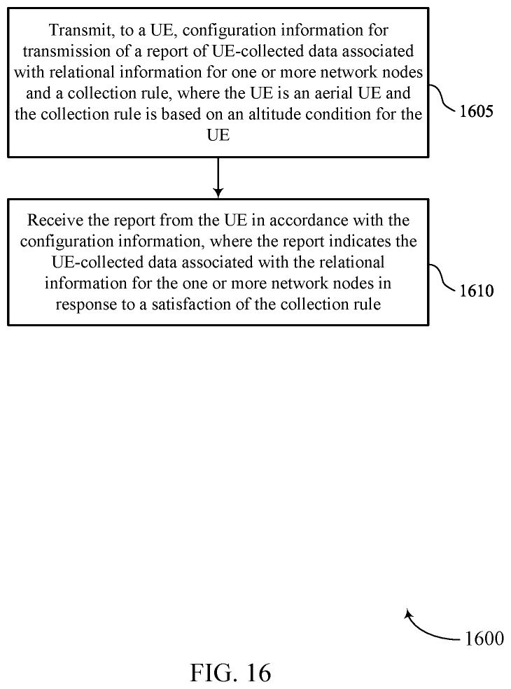

FIG. 16 shows a flowchart illustrating a method 1600 that supports reporting enhancements for UEs in accordance with aspects of the present disclosure. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1605, the method may include transmitting, to a UE, configuration information for transmission of a report of UE-collected data associated with relational information for one or more network nodes and a collection rule, where the UE is an aerial UE and the collection rule is based on an altitude condition for the UE. The operations of block 1605 may be performed in accordance with examples as disclosed herein. In some examples, aspects of the operations of 1605 may be performed by a configuration manager 1225 as described with reference to FIG. 12. Additionally, or alternatively, means for performing 1605 may, but not necessarily, include, for example, antenna 1315, transceiver 1310, communications manager 1320, memory 1325 (including code 1330), processor 1335, or bus 1340.

At 1610, the method may include receiving the report from the UE in accordance with the configuration information, where the report indicates the UE-collected data associated with the relational information for the one or more network nodes in response to a satisfaction of the collection rule. The operations of block 1610 may be performed in accordance with examples as disclosed herein. In some examples, aspects of the operations of 1610 may be performed by a report manager 1230 as described with reference to FIG. 12. Additionally, or alternatively, means for performing 1610 may, but not necessarily, include, for example, antenna 1315, transceiver 1310, communications manager 1320, memory 1325 (including code 1330), processor 1335, or bus 1340.

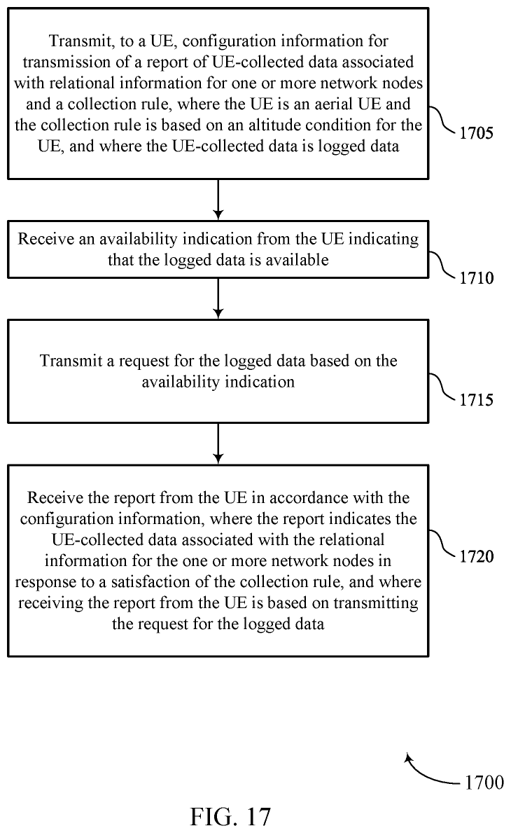

FIG. 17 shows a flowchart illustrating a method 1700 that supports reporting enhancements for UEs in accordance with aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include transmitting, to a UE, configuration information for transmission of a report of UE-collected data associated with relational information for one or more network nodes and a collection rule, where the UE is an aerial UE and the collection rule is based on an altitude condition for the UE, and where the UE-collected data is logged data. The operations of block 1705 may be performed in accordance with examples as disclosed herein. In some examples, aspects of the operations of 1705 may be performed by a configuration manager 1225 as described with reference to FIG. 12. Additionally, or alternatively, means for performing 1705 may, but not necessarily, include, for example, antenna 1315, transceiver 1310, communications manager 1320, memory 1325 (including code 1330), processor 1335, or bus 1340.

At 1710, the method may include receiving an availability indication from the UE indicating that the logged data is available. The operations of block 1710 may be performed in accordance with examples as disclosed herein. In some examples, aspects of the operations of 1710 may be performed by an availability manager 1235 as described with reference to FIG. 12. Additionally, or alternatively, means for performing 1710 may, but not necessarily, include, for example, antenna 1315, transceiver 1310, communications manager 1320, memory 1325 (including code 1330), processor 1335, or bus 1340.

At 1715, the method may include transmitting a request for the logged data based on the availability indication. The operations of block 1715 may be performed in accordance with examples as disclosed herein. In some examples, aspects of the operations of 1715 may be performed by a request manager 1240 as described with reference to FIG. 12. Additionally, or alternatively, means for performing 1715 may, but not necessarily, include, for example, antenna 1315, transceiver 1310, communications manager 1320, memory 1325 (including code 1330), processor 1335, or bus 1340.

At 1720, the method may include receiving the report from the UE in accordance with the configuration information, where the report indicates the UE-collected data associated with the relational information for the one or more network nodes in response to a satisfaction of the collection rule, and where receiving the report from the UE is based on transmitting the request for the logged data. The operations of block 1720 may be performed in accordance with examples as disclosed herein. In some examples, aspects of the operations of 1720 may be performed by a report manager 1230 as described with reference to FIG. 12. Additionally, or alternatively, means for performing 1720 may, but not necessarily, include, for example, antenna 1315, transceiver 1310, communications manager 1320, memory 1325 (including code 1330), processor 1335, or bus 1340.

The following provides an overview of aspects of the present disclosure:

Aspect 1: A method for wireless communications at a UE, comprising: receiving, from a network entity, configuration information for transmission of a report of UE-collected data associated with relational information for one or more network nodes and a collection rule, wherein the UE is an aerial UE and the collection rule is based at least in part on an altitude condition for the UE; and transmitting the report to the network entity in accordance with the configuration information, wherein the report indicates the UE-collected data associated with the relational information for the one or more network nodes in response to a satisfaction of the collection rule.

Aspect 2: The method of aspect 1, wherein the altitude condition for the UE comprises at least one altitude threshold for an altitude of the UE, and the UE-collected data comprises handover data or cell change data collected by the UE in response to the altitude of the UE satisfying the at least one altitude threshold.

Aspect 3: The method of any of aspects 1 through 2, wherein receiving the configuration information comprises: receiving information indicating an area scope that is based at least in part on the altitude condition, wherein the UE-collected data comprises data collected by the UE in response to a satisfaction of the area scope.

Aspect 4: The method of aspect 3, wherein the configuration information further comprises one or more cell indicators, and the UE-collected data comprises data collected by the UE for one or more cells associated with the one or more cell indicators.

Aspect 5: The method of aspect 4, wherein the altitude condition for the UE comprises at least one altitude threshold for an altitude of the UE, the method further comprising: collecting first data associated with one or more first cells of the one or more cells in response to a satisfaction of a first threshold of the at least one altitude threshold.

Aspect 6: The method of any of aspects 1 through 5, wherein the collection rule is further based at least in part on a signal quality condition, the altitude condition comprising at least one altitude threshold for an altitude of the UE, and the UE-collected data comprises data collected by the UE in response to a satisfaction of the signal quality condition and the altitude of the UE satisfying the at least one altitude threshold.

Aspect 7: The method of aspect 6, further comprising: receiving one or more reference signals corresponding to one or more cells, wherein satisfaction of the signal quality condition comprises one or more measures of the one or more reference signals satisfying a signal quality threshold.

Aspect 8: The method of any of aspects 1 through 7, further comprising: detecting an entrance of the UE into a restricted zone, wherein the UE refrains from collecting data while in the restricted zone and collects the UE-collected data while outside of the restricted zone.

Aspect 9: The method of aspect 8, wherein the UE-collected data comprises first data indicating an entrance into the restricted zone, second data indicating an exit from the restricted zone, third data indicating that the UE is within a distance from the restricted zone, or any combination thereof.

Aspect 10: The method of any of aspects 1 through 9, wherein receiving the configuration information comprises: receiving cell report configuration information instructing the UE to collect cell data associated with one or more cells in response to a satisfaction of the altitude condition, and transmitting the report comprises transmitting a cell report comprising the cell data associated with the one or more cells.

Aspect 11: The method of aspect 10, wherein the cell data is included in an ANR table.

Aspect 12: The method of any of aspects 1 through 11, wherein transmitting the report comprises: transmitting UE characteristic data associated with the UE, altitude data associated with the UE, detected aerial UE density data, or any combination thereof.

Aspect 13: The method of any of aspects 1 through 12, wherein the report is a RA report, a CEF report, a RLF report, a SHR, a SPR, or a report comprising SCG failure information.

Aspect 14: The method of any of aspects 1 through 13, wherein the UE-collected data is logged data, the method further comprising: transmitting an availability indication to the network entity indicating that the logged data is available; and receiving a request for the logged data based at least in part on the availability indication, wherein transmitting the report to the network entity is based at least in part on receiving the request for the logged data.

Aspect 15: A method for wireless communications by a network entity, comprising: transmitting, to a UE, configuration information for transmission of a report of UE-collected data associated with relational information for one or more network nodes and a collection rule, wherein the UE is an aerial UE and the collection rule is based at least in part on an altitude condition for the UE; and receiving the report from the UE in accordance with the configuration information, wherein the report indicates the UE-collected data associated with the relational information for the one or more network nodes in response to a satisfaction of the collection rule.

Aspect 16: The method of aspect 15, wherein the altitude condition for the UE comprises at least one altitude threshold for an altitude of the UE, and the UE-collected data comprises handover data or cell change data collected by the UE in response to the altitude of the UE satisfying the at least one altitude threshold.

Aspect 17: The method of any of aspects 15 through 16, wherein transmitting the configuration information comprises: transmitting information indicating an area scope that is based at least in part on the altitude condition, wherein the UE-collected data comprises data collected by the UE in response to a satisfaction of the area scope.

Aspect 18: The method of aspect 17, wherein the configuration information further comprises one or more cell indicators, and the UE-collected data comprises data collected by the UE for one or more cells associated with the one or more cell indicators.

Aspect 19: The method of aspect 18, wherein the altitude condition for the UE comprises at least one altitude threshold for an altitude of the UE.

Aspect 20: The method of any of aspects 15 through 19, wherein the collection rule is further based at least in part on a signal quality condition, the altitude condition comprising at least one altitude threshold for an altitude of the UE, and the UE-collected data comprises data collected by the UE in response to a satisfaction of the signal quality condition and the altitude of the UE satisfying the at least one altitude threshold.

Aspect 21: The method of aspect 20, wherein receiving the report further comprises: receiving data indicating one or more reference signals corresponding to one or more cells, wherein the data indicating one or more reference signals is collected by the UE in response to satisfaction of the signal quality condition that comprises one or more measures of the one or more reference signals satisfying a signal quality threshold.

Aspect 22: The method of any of aspects 15 through 21, wherein the UE-collected data lacks data associated with a restricted zone and comprises data associated with one or more areas outside of the restricted zone.

Aspect 23: The method of aspect 22, wherein the UE-collected data comprises first data indicating an entrance into the restricted zone, second data indicating an exit from the restricted zone, third data indicating that the UE is within a distance from the restricted zone, or any combination thereof.

Aspect 24: The method of any of aspects 15 through 23, wherein transmitting the configuration information comprises: transmitting cell report configuration information instructing the UE to collect cell data associated with one or more cells in response to a satisfaction of the altitude condition, and receiving the report comprises receiving a cell report comprising the cell data associated with the one or more cells.

Aspect 25: The method of aspect 24, wherein the cell data is included in an ANR table.

Aspect 26: The method of any of aspects 15 through 25, wherein receiving the report comprises: receiving UE characteristic data associated with the UE, altitude data associated with the UE, detected aerial UE density data, or any combination thereof.

Aspect 27: The method of any of aspects 15 through 26, wherein the report is a RA report, a CEF report, a RLF report, a SHR, a SPR, or a report comprising SCG failure information.

Aspect 28: The method of any of aspects 15 through 27, wherein the UE-collected data is logged data, the method further comprising: receiving an availability indication from the UE indicating that the logged data is available; and transmitting a request for the logged data based at least in part on the availability indication, wherein receiving the report from the UE is based at least in part on transmitting the request for the logged data.

Aspect 29: An apparatus for wireless communications, comprising memory, a transceiver, and at least one processor of a UE, the at least one processor coupled with the memory and the transceiver, and the at least one processor configured to cause the apparatus to perform a method of any of aspects 1 through 14.

Aspect 30: An apparatus for wireless communications, comprising at least one means for performing a method of any of aspects 1 through 14.

Aspect 31: A non-transitory computer-readable medium storing code the code comprising instructions executable by one or more processors to perform a method of any of aspects 1 through 14.

Aspect 32: An apparatus for wireless communications, comprising memory and at least one processor coupled with the memory, the at least one processor configured to cause the apparatus to perform a method of any of aspects 15 through 28.

Aspect 33: An apparatus for wireless communications, comprising at least one means for performing a method of any of aspects 15 through 28.

Aspect 34: A non-transitory computer-readable medium storing code the code comprising instructions executable by one or more processors to perform a method of any of aspects 15 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communication systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication, comprising:
memory;
a transceiver; and
at least one processor of a user equipment (UE), the at least one processor coupled with the memory and the transceiver and configured to cause the apparatus to:
receive, via the transceiver from a network entity, configuration information for transmission of a report of UE-collected data associated with relational information for one or more network nodes and a collection rule, wherein the UE is an aerial UE and the collection rule is based at least in part on an altitude condition for the UE; and
transmit, via the transceiver, the report to the network entity in accordance with the configuration information, wherein the report indicates the UE-collected data associated with the relational information for the one or more network nodes in response to a satisfaction of the collection rule.

2. The apparatus of claim 1, wherein the altitude condition for the UE comprises at least one altitude threshold for an altitude of the UE, and the UE-collected data comprises handover data or cell change data collected by the UE in response to the altitude of the UE satisfying the at least one altitude threshold.

3. The apparatus of claim 1, wherein, to receive the configuration information, the at least one processor is configured to cause the apparatus to:
receive information indicating an area scope that is based at least in part on the altitude condition, wherein the UE-collected data comprises data collected by the UE in response to a satisfaction of the area scope.

4. The apparatus of claim 3, wherein:
the configuration information further comprises one or more cell indicators, and
the UE-collected data comprises data collected by the UE for one or more cells associated with the one or more cell indicators.

5. The apparatus of claim 4, wherein the altitude condition for the UE comprises at least one altitude threshold for an altitude of the UE, and wherein the at least one processor is further configured to cause the apparatus to:
collect first data associated with one or more first cells of the one or more cells in response to a satisfaction of a first threshold of the at least one altitude threshold.

6. The apparatus of claim 1, wherein:
the collection rule is further based at least in part on a signal quality condition, the altitude condition comprising at least one altitude threshold for an altitude of the UE, and
the UE-collected data comprises data collected by the UE in response to a satisfaction of the signal quality condition and the altitude of the UE satisfying the at least one altitude threshold.

7. The apparatus of claim 6, wherein the at least one processor is further configured to cause the apparatus to:
receive one or more reference signals corresponding to one or more cells, wherein satisfaction of the signal quality condition comprises one or more measures of the one or more reference signals satisfying a signal quality threshold.

8. The apparatus of claim 1, wherein the at least one processor is further configured to cause the apparatus to:
detect an entrance of the UE into a restricted zone, wherein the at least one processor is further configured to cause the apparatus to refrain from collecting data while in the restricted zone and collect the UE-collected data while outside of the restricted zone.

9. The apparatus of claim 8, wherein the UE-collected data comprises first data indicating the entrance into the restricted zone, second data indicating an exit from the restricted zone, third data indicating that the UE is within a distance from the restricted zone, or any combination thereof.

10. The apparatus of claim 1, wherein:
to receive the configuration information, the at least one processor is configured to cause the apparatus to receive cell report configuration information instructing the UE to collect cell data associated with one or more cells in response to a satisfaction of the altitude condition; and
to transmit the report, the at least one processor is configured to cause the apparatus to transmit a cell report comprising the cell data associated with the one or more cells.

11. The apparatus of claim 10, wherein the cell data is included in an automatic neighbor relation table.

12. The apparatus of claim 1, wherein, to transmit the report, the at least one processor is configured to cause the apparatus to:
transmit UE characteristic data associated with the UE, altitude data associated with the UE, detected aerial UE density data, or any combination thereof.

13. The apparatus of claim 1, wherein the report is a random access report, a connection establishment failure report, a radio link failure report, a successful handover report, a successful primary secondary cell change report, or a report comprising secondary cell group failure information.

14. The apparatus of claim 1, wherein the UE-collected data is logged data, and wherein the at least one processor is further configured to cause the apparatus to:
transmit an availability indication to the network entity indicating that the logged data is available; and
receive a request for the logged data based at least in part on the availability indication, wherein the at least one processor is configured to cause the apparatus to transmit the report to the network entity based at least in part on receiving the request for the logged data.

15. An apparatus for wireless communication, comprising:
memory; and
at least one processor of a network entity, the at least one processor coupled with the memory and configured to cause the apparatus to:
transmit, to a user equipment (UE), configuration information for transmission of a report of UE-collected data associated with relational information for one or more network nodes and a collection rule, wherein the UE is an aerial UE and the collection rule is based at least in part on an altitude condition for the UE; and
receive the report from the UE in accordance with the configuration information, wherein the report indicates the UE-collected data associated with the relational information for the one or more network nodes in response to a satisfaction of the collection rule.

16. The apparatus of claim 15, wherein the altitude condition for the UE comprises at least one altitude threshold for an altitude of the UE, and the UE-collected data comprises handover data or cell change data collected by the UE in response to the altitude of the UE satisfying the at least one altitude threshold.

17. The apparatus of claim 15, wherein, to transmit the configuration information, the at least one processor is configured to cause the apparatus to:
transmit information indicating an area scope that is based at least in part on the altitude condition, wherein the UE-collected data comprises data collected by the UE in response to a satisfaction of the area scope.

18. The apparatus of claim 17, wherein:
the configuration information further comprises one or more cell indicators, and
the UE-collected data comprises data collected by the UE for one or more cells associated with the one or more cell indicators.

19. The apparatus of claim 18, wherein:
the altitude condition for the UE comprises at least one altitude threshold for an altitude of the UE.

20. The apparatus of claim 15, wherein:
the collection rule is further based at least in part on a signal quality condition, the altitude condition comprising at least one altitude threshold for an altitude of the UE, and
the UE-collected data comprises data collected by the UE in response to a satisfaction of the signal quality condition and the altitude of the UE satisfying the at least one altitude threshold.

21. The apparatus of claim 20, wherein, to receive the report, the at least one processor is configured to cause the apparatus to:
receive data indicating one or more reference signals corresponding to one or more cells, wherein collection by the UE of the data indicating one or more reference signals is in response to satisfaction of the signal quality condition that comprises one or more measures of the one or more reference signals satisfying a signal quality threshold.

22. The apparatus of claim 15, wherein the UE-collected data lacks data associated with a restricted zone and comprises data associated with one or more areas outside of the restricted zone.

23. The apparatus of claim 22, wherein the UE-collected data comprises first data indicating an entrance into the restricted zone, second data indicating an exit from the restricted zone, third data indicating that the UE is within a distance from the restricted zone, or any combination thereof.

24. The apparatus of claim 15, wherein:
to transmit the configuration information, the at least one processor is configured to cause the apparatus to transmit cell report configuration information instructing the UE to collect cell data associated with one or more cells in response to a satisfaction of the altitude condition; and
to receive the report, the at least one processor is configured to cause the apparatus to receive a cell report comprising the cell data associated with the one or more cells.

25. The apparatus of claim 24, wherein the cell data is included in an automatic neighbor relation table.

26. The apparatus of claim 15, wherein, to receive the report, the at least one processor is configured to cause the apparatus to:
receive UE characteristic data associated with the UE, altitude data associated with the UE, detected aerial UE density data, or any combination thereof.

27. The apparatus of claim 15, wherein the report is a random access report, a connection establishment failure report, a radio link failure report, a successful handover report, a successful primary secondary cell change report, or a report comprising secondary cell group failure information.

28. The apparatus of claim 15, wherein the UE-collected data is logged data, and wherein the at least one processor is further configured to cause the apparatus to:
receive an availability indication from the UE indicating that the logged data is available; and
transmit a request for the logged data based at least in part on the availability indication, wherein the at least one processor is configured to cause the apparatus to receive the report from the UE based at least in part on transmitting the request for the logged data.

29. A method for wireless communications at a user equipment (UE), comprising:
receiving, from a network entity, configuration information for transmission of a report of UE-collected data associated with relational information for one or more network nodes and a collection rule, wherein the UE is an aerial UE and the collection rule is based at least in part on an altitude condition for the UE; and
transmitting the report to the network entity in accordance with the configuration information, wherein the report indicates UE-collected data associated with the relational information for the one or more network nodes in response to a satisfaction of the collection rule.

30. A method for wireless communications by a network entity, comprising:
transmitting, to a user equipment (UE), configuration information for transmission of a report of UE-collected data associated with relational information for one or more network nodes and a collection rule, wherein the UE is an aerial UE and the collection rule is based at least in part on an altitude condition for the UE; and
receiving the report from the UE in accordance with the configuration information, wherein the report indicates UE-collected data associated with the relational information for the one or more network nodes in response to a satisfaction of the collection rule.
